(19) United States
(12) Patent Application Publication
(10) Pub. No.: US 2026/0315301 A1
(43) Pub. Date: Oct. 15, 2026

(54) EXOSKELETON DEVICE AND METHOD

(71) Applicant: The Catholic University of America, washington, DC (US)

(72) Inventors: Rafael CASAS, Baltimore, MD (US); Peter LUM, Clarksburg, MD (US)

(21) Appl. No.: 19/637,105

(22) Filed: Apr. 2, 2026

Related U.S. Application Data
(60) Provisional application No. 63/788,437, filed on Apr. 14, 2025.

(51) Int. Cl. A61H 1/02; B25J 9/00

(52) U.S. Cl. CPC A61H 1/0288; B25J 9/0006; A61H 2201/1638; A61H 2201/5043; A61H 2201/5061; A61H 2201/5064; A61H 2201/5069

(57) ABSTRACT

A wearable hand exoskeleton system configured to assist and rehabilitate hand function in individuals with neurological or musculoskeletal impairment is disclosed. The device includes a dorsal support structure, finger assemblies, and a thumb assembly coupled that coordinates motion of metacarpophalangeal joints of the fingers with motion of a carpometacarpal joint of the thumb producing functional grasp patterns. Extension assistance is provided by at least one resilient biasing member and/or a linear actuator. Passive degrees of freedom are provided at proximal interphalangeal joints and thumb flexion/extension joints to enable natural C-grasp and pinch configurations. Actuated embodiments include a force sensor configured to detect user-generated flexion force and a control system to assist grasp and release. The system further includes position sensing, activity tracking, wireless communication, and a mobile application for rehabilitation monitoring. The device is lightweight, untethered, and configured for use in both assistive daily activities and home-based therapy.

### CROSS-REFERENCE TO RELATED APPLICATIONS

This application claims benefit of priority of U.S. Patent Application No. 63/788,437 entitled, “EXOSKELETON DEVICE” filed Apr. 14, 2025. The entire contents and disclosures of these patent applications are incorporated herein by reference in their entirety.

### GOVERNMENT INTEREST STATEMENT

The government has certain rights in the invention. Grant number 90BISA0054 (SBIR Phase I) from the National Institute on Disability, Independent Living and Rehabilitation, Administration for Community Living of the U.S. Department of Health and Human Services; Grant number 90BISA0072 (SBIR Phase I) from the National Institute on Disability, Independent Living and Rehabilitation, Administration for Community Living of the U.S. Department of Health and Human Services; and Grant number 90REGE0004 (RERC-DC) from the National Institute on Disability, Independent Living and Rehabilitation, Administration for Community Living of the U.S. Department of Health and Human Services.

### BACKGROUND

### Field of the Invention

The present disclosure relates generally to wearable orthopedic and robotic assistive devices, and more particularly to hand exoskeleton systems configured to assist, augment, and rehabilitate grasp and hand opening functions in individuals with neurological or musculoskeletal impairments. The invention encompasses both passively powered and actively actuated embodiments that provide coordinated multi-joint assistance to the fingers and thumb.

### Background of the Invention

Loss of functional hand use is a common and disabling consequence of stroke, spinal cord injury, cerebral palsy, arthritis, hand contracture, and other neuromuscular disorders. Individuals affected by such conditions frequently retain partial voluntary flexion capability but experience weakness in finger extension, abnormal flexor tone, impaired coordination among digits, reduced range of motion, and difficulty forming stable grasp patterns necessary for activities of daily living. Restoration of controlled hand opening and functional grasp is therefore central to both assistive independence and neurorehabilitation.

Various hand orthoses and robotic exoskeleton systems have been developed in an attempt to restore grasp and release capabilities. Passive spring-driven devices often attach elastic elements directly to the fingers to bias them toward extension. Such direct spring attachments typically produce extension torque that increases with flexion, thereby resisting voluntary closing of the hand and limiting effective grasp strength and range of motion. Many of these systems provide limited degrees of freedom and fail to coordinate thumb motion with finger motion in a manner that reproduces natural grasp kinematics.

Powered exoskeleton systems employing electric motors or pneumatic actuators have also been proposed. Although these systems can provide programmable assistance, they often rely on multiple independent actuators for individual finger control, increasing mechanical complexity, component count, weight, cost, and control requirements. Pneumatic systems may require tethering to compressors or external hardware and may perform only preprogrammed passive movement cycles without responding to user-generated force. Bulky dorsal structures and obstructed palmar surfaces may interfere with real-world object manipulation and limit use outside clinical settings.

Accordingly, there remains a need for a lightweight, mechanically efficient, wearable hand exoskeleton that provides coordinated multi-digit grasp, offers a favorable torque profile that facilitates voluntary flexion, accommodates varying hand sizes, supports voluntary intent detection, operates untethered, and enables rehabilitation monitoring in home-based environments.

### SUMMARY

According to first broad aspect, the present disclosure provides a wearable hand exoskeleton device comprising: a dorsal support structure configured to be positioned along a back of a user’s hand; a plurality of finger assemblies coupled to the dorsal support structure, each finger assembly configured to attach to a respective finger of the user; a thumb assembly coupled to the dorsal support structure and configured to attach to a thumb of the user; a linkage mechanism coupling motion of metacarpophalangeal (MCP) joints of the fingers with motion of a carpometacarpal (CMC) joint of the thumb; and at least one resilient biasing member configured to provide extension assistance to the MCP joints and the CMC joint, wherein the linkage mechanism coordinates movement of the fingers and thumb to generate a functional grasp pattern.

According to a second broad aspect, the present disclosure provides a wearable hand exoskeleton device comprising: a dorsal frame configured to be worn on a back of a user’s hand; a plurality of finger linkages operatively coupled to respective fingers; a thumb linkage operatively coupled to a thumb; a coupling mechanism configured to coordinate movement of the finger linkages and the thumb linkage; a linear actuator mechanically coupled to the coupling mechanism; and a control system configured to actuate the linear actuator to assist extension and flexion of the fingers and thumb.

According to a third broad aspect, the present disclosure provides a hand rehabilitation system comprising: a wearable hand exoskeleton device including a dorsal frame, a plurality of finger assemblies, a thumb assembly, and at least one actuation element configured to assist grasp and extension; a position sensor configured to detect angular displacement of at least one joint; a control unit configured to record movement data; and a wireless communication module configured to transmit the movement data to an external computing device.

According to a fourth broad aspect, the present disclosure provides a method of assisting and rehabilitating hand function of a user, comprising: positioning a wearable hand exoskeleton on a dorsal side of the user’s hand, the exoskeleton including a plurality of finger linkages, a thumb linkage, and at least one assistance element configured to provide extension torque; coupling motion of metacarpophalangeal (MCP) joints of the fingers with motion of a carpometacarpal (CMC) joint of the thumb using a linkage mechanism; providing extension assistance to the fingers and thumb through at least one resilient biasing member or actuator; allowing the user to voluntarily flex the fingers against the extension assistance to grasp an object; and assisting reopening of the hand to release the object.

According to a fifth broad aspect, the present disclosure provides a non-transitory computer-readable medium storing instructions that, when executed by a processor of a wearable hand exoskeleton device, cause the device to: receive input from at least one sensor associated with a finger or thumb linkage; determine a user intent to flex or extend the hand based on the sensor input; control an actuation element to provide assistive torque to the fingers and thumb; and record movement data associated with grasp and release cycles.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

The accompanying drawings, which are incorporated herein and constitute part of this specification, illustrate exemplary embodiments of the invention, and, together with the general description given above and the detailed description given below, serve to explain the features of the invention.

FIG. 1 illustrates the evolutionary progression of the disclosed hand exoskeleton systems from purely passive mechanical embodiments to actively powered configurations. according to one embodiment of the present disclosure.

FIG. 2 illustrates representative embodiments of the enhanced hand exoskeleton configuration incorporating additional passive spring-assisted degrees of freedom to improve grasp versatility and joint kinematics according to one embodiment of the present disclosure.

FIG. 3 illustrates representative torque-angle profiles generated by varying anchor positions of the resilient biasing members used to provide extension assistance according to one embodiment of the present disclosure.

FIG. 4 illustrates an exemplary sequence of donning procedure according to one embodiment of the present disclosure.

FIG. 5 illustrates the evolutionary progression of the disclosed hand exoskeleton systems from purely passive mechanical embodiments to actively powered configurations according to one embodiment of the present disclosure.

FIG. 6 illustrates representative views of the enhanced grasp configuration enabled by an actively powered hand exoskeleton according to one embodiment of the present disclosure.

FIG. 7 illustrates a computer-aided design (CAD) representation of an enhanced low-profile embodiment of the hand exoskeleton device according to one embodiment of the present disclosure.

### DETAILED DESCRIPTION OF THE INVENTION

### Definitions

Where the definition of terms departs from the commonly used meaning of the term, applicant intends to utilize the definitions provided below, unless specifically indicated.

It is to be understood that the foregoing general description and the following detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

For purposes of the present disclosure, the term “comprising”, the term “having”, the term “including,” and variations of these words are intended to be open-ended and mean that there may be additional elements other than the listed elements.

For purposes of the present disclosure, directional terms such as “top,” “bottom,” “upper,” “lower,” “above,” “below,” “left,” “right,” “horizontal,” “vertical,” “up,” “down,” etc., are used merely for convenience in describing the various embodiments of the present disclosure. The embodiments of the present disclosure may be oriented in various ways. For example, the diagrams, apparatuses, etc., shown in the drawing figures may be flipped over, rotated by 90º in any direction, reversed, etc.

For purposes of the present disclosure, a value or property is “based” on a particular value, property, the satisfaction of a condition, or other factor, if that value is derived by performing a mathematical calculation or logical decision using that value, property or other factor.

For purposes of the present disclosure, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

For purposes of the present disclosure, the term “associated” with respect to data refers to data that are associated or linked to each other. For example, data relating the identity of an individual (identity data) wearing an integrated sensor module may be associated with the motion data for the individual obtained from an accelerometer or, optionally, from a gyroscope or, optionally, from the amplitude of the power signal from an energy harvester.

For the purposes of the present disclosure, the term “Bluetooth^{®}” refers to a wireless technology standard for exchanging data over short distances (using short-wavelength radio transmissions in the ISM band from 2400–2480 MHz) from fixed and mobile devices, creating personal area networks (PANs) with high levels of security. Created by telecom vendor Ericsson in 1994, it was originally conceived as a wireless alternative to RS-232 data cables. It can connect several devices, overcoming problems of synchronization. Bluetooth^{®} is managed by the Bluetooth^{®} Special Interest Group, which has more than 18,000 member companies in the areas of telecommunication, computing, networking, and consumer electronics. Bluetooth^{®} was standardized as IEEE 802.15.1, but the standard is no longer maintained. The SIG oversees the development of the specification, manages the qualification program, and protects the trademarks. To be marketed as a Bluetooth^{®} device, it must be qualified to standards defined by the SIG. A network of patents is required to implement the technology and are licensed only for those qualifying devices.

For purposes of the present disclosure, the term “carpometacarpal joint” or “CMC joint” refers to the anatomical joint formed between a carpal bone of the wrist and the base of a metacarpal bone. In the thumb, the carpometacarpal joint, sometimes referred to as the trapeziometacarpal joint, permits flexion, extension, abduction, adduction, circumduction, and opposition, and plays a primary role in functional grasp and pinch patterns. In the fingers, carpometacarpal joints provide limited motion and contribute to overall hand conformation during grasp. References to movement or assistance at a CMC joint include any mechanical support, torque application, actuation, or coupling configured to influence motion of the metacarpal relative to the carpal bones, including coordinated movement with one or more finger joints.

For purposes of the present disclosure, the term “computer” refers to any type of computer or other device that implements software including an individual computer such as a personal computer, laptop computer, tablet computer, mainframe computer, mini-computer, etc. A computer also refers to electronic devices such as an electronic scientific instrument such as a spectrometer, a smartphone, an eBook reader, a cell phone, a television, a handheld electronic game console, a videogame console, a compressed audio or video player such as an MP3 player, a Blu-ray player, a DVD player, etc. In addition, the term “computer” refers to any type of network of computers, such as a network of computers in a business, a computer bank, the Cloud, the Internet, etc. Various processes of the present disclosure may be carried out using a computer. Various functions of the present disclosure may be performed by one or more computers.

For the purposes of the present disclosure, the term “computer hardware” and the term “hardware” refer to the digital circuitry and physical devices of a computer system, as opposed to computer software, which is stored on a hardware device such as a hard disk. Most computer hardware is not seen by normal users, because it is embedded within a variety of every day systems, such as in automobiles, microwave ovens, electrocardiograph machines, compact disc players, and video games, among many others. A typical personal computer consists of a case or chassis in a tower shape (desktop) and the following parts: motherboard, CPU, RAM, firmware, internal buses (PIC, PCI-E, USB, HyperTransport, CSI, AGP, VLB), external bus controllers (parallel port, serial port, USB, Firewire, SCSI. PS/2, ISA, EISA, MCA), power supply, case control with cooling fan, storage controllers (CD-ROM, DVD, DVD-ROM, DVD Writer, DVD RAM Drive, Blu-ray, BD-ROM, BD Writer, floppy disk, USB Flash, tape drives, SATA, SAS), video controller, sound card, network controllers (modem, NIC), and peripherals, including mice, keyboards, pointing devices, gaming devices, scanner, webcam, audio devices, printers, monitors, etc.

For the purposes of the present disclosure, the term “computer software” and the term “software” refers to one or more computer programs, procedures and documentation that perform some tasks on a computer system. The term includes application software such as word processors which perform productive tasks for users, system software such as operating systems, which interface with hardware to provide the necessary services for application software, and middleware which controls and co-ordinates distributed systems. Software may include websites, programs, video games, etc. that are coded by programming languages like C, C++, Java, etc. Computer software is usually regarded as anything but hardware, meaning the “hard” are the parts that are tangible (able to hold) while the “soft” part is the intangible objects inside the computer. Computer software is so called to distinguish it from computer hardware, which encompasses the physical interconnections and devices required to store and execute (or run) the software. At the lowest level, software consists of a machine language specific to an individual processor. A machine language consists of groups of binary values signifying processor instructions which change the state of the computer from its preceding state.

For the purposes of the present disclosure, the term “computer system” refers to any type of computer system that implements software including an individual computer such as a personal computer, mainframe computer, mini-computer, etc. In addition, computer system refers to any type of network of computers, such as a network of computers in a business, the Internet, personal data assistant (PDA), devices such as a cell phone, a television, a videogame console, a compressed audio or video player such as an MP3 player, a DVD player, a microwave oven, etc. A personal computer is one type of computer system that typically includes the following components: a case or chassis in a tower shape (desktop) and the following parts: motherboard, CPU, RAM, firmware, internal buses (PIC, PCI-E, USB, HyperTransport, CSI, AGP, VLB), external bus controllers (parallel port, serial port, USB, Firewire, SCSI. PS/2, ISA, EISA, MCA), power supply, case control with cooling fan, storage controllers (CD-ROM, DVD, DVD-ROM, DVD Writer, DVD RAM Drive, Blu-ray, BD-ROM, BD Writer, floppy disk, USB Flash, tape drives, SATA, SAS), video controller, sound card, network controllers (modem, NIC), and peripherals, including mice, keyboards, pointing devices, gaming devices, scanner, webcam, audio devices, printers, monitors, etc.

For the purposes of the present disclosure, the term “coordinated grasp pattern” refers to a synchronized movement relationship between two or more digits, including one or more fingers and the thumb, in which motion of at least one joint of a first digit is mechanically or electronically linked to motion of at least one joint of another digit to produce a repeatable and functional object-engagement posture. Coordinated grasp patterns may include pinch-pad grasp, C-grasp, cylindrical grasp, spherical grasp, or other multi-digit configurations suitable for stabilizing or manipulating objects. The term does not require independent control of each digit and encompasses mechanically coupled or actuator-driven multi-digit motion.

For the purposes of the present disclosure, the term “data” means the reinterpretable representation of information in a formalized manner suitable for communication, interpretation, or processing. Although one type of common type data is a computer file, data may also be streaming data, a web service, etc. The term “data” is used to refer to one or more pieces of data.

For the purposes of the present disclosure, the term “database” or “data record” refers to a structured collection of records or data that is stored in a computer system. The structure is achieved by organizing the data according to a database model. The model in most common use today is the relational model. Other models such as the hierarchical model and the network model use a more explicit representation of relationships (see below for explanation of the various database models). A computer database relies upon software to organize the storage of data. This software is known as a database management system (DBMS). Database management systems are categorized according to the database model that they support. The model tends to determine the query languages that are available to access the database. A great deal of the internal engineering of a DBMS, however, is independent of the data model, and is concerned with managing factors such as performance, concurrency, integrity, and recovery from hardware failures. In these areas there are large differences between products.

For the purposes of the present disclosure, the term “data storage medium” or “data storage device” refers to any medium or media on which a data may be stored for use by a computer system. Examples of data storage media include floppy disks, Zip^{TM} disks, CD-ROM, CD-R, CD-RW, DVD, DVD-R, memory sticks, flash memory, hard disks, solid state disks, optical disks, etc. Two or more data storage media acting similarly to a single data storage medium may be referred to as a “data storage medium” for the purposes of the present disclosure. A data storage medium may be part of a computer.

For the purposes of the present disclosure, the term “distal” refers to a position farther from the user’s wrist or farther from the user’s body along a given anatomical structure. With respect to the fingers, a distal joint or segment is one that is nearer the fingertip relative to another joint or segment of the same finger. For example, the distal interphalangeal joint is distal relative to the proximal interphalangeal joint, and a distal attachment ring is positioned nearer the fingertip than a proximal attachment structure.

For the purposes of the present disclosure, the term “dorsal” refers to the back side of the hand opposite the palmar surface. A dorsal support structure is positioned along the back of the hand overlying the metacarpal region and is configured to permit the palmar surface to remain substantially unobstructed for contact with objects during grasping tasks.

For the purposes of the present disclosure, the term “exoskeleton” refers to a wearable device that helps a user move and perform tasks by increasing mobility and in some cases their strength. Exoskeletons can be used for a variety of purposes, including medical, military, and industrial applications. An exoskeleton may generally be considered to be a hard mechanical frame with joints that allow movement of the human operator. There are other types of exoskeletons that are softer and are worn on the body, supported by the internal skeleton of the human being. Exoskeletons may incorporate sensors that detect a user's intentions and movements. The sensors may be configured to send information to an onboard artificial intelligence (AI), which may predict the user's next move(s). Actuators may be employed as motors in the exoskeleton to drive the user's movements. Exoskeletons can help people with conditions that limit their mobility, such as spinal cord injuries, stroke, Parkinson's disease, and multiple sclerosis.

For the purposes of the present disclosure, the term “extension assistance” refers to any mechanical, elastic, or powered force or torque applied to a finger or thumb joint in a direction that biases the joint toward extension, opening, or straightening relative to a flexed position. Extension assistance may be generated by resilient biasing members such as springs or elastic elements, by motor-driven actuators, or by combinations thereof. Extension assistance may be constant, variable, adjustable, or dynamically controlled, and may be configured to produce a torque profile that changes as a function of joint angle.

For the purposes of the present disclosure, the term “functional grasp pattern” refers to a coordinated configuration of one or more fingers and the thumb that enables a user to securely engage, stabilize, manipulate, or release an object in a manner consistent with performance of activities of daily living. A functional grasp pattern may include, without limitation, pinch-pad grasp, lateral pinch, cylindrical grasp, spherical grasp, C-grasp, tripod grasp, or other multi-digit configurations in which relative positioning and movement of the digits permit effective object acquisition and retention. References to generating or assisting a functional grasp pattern include mechanically coupling digit motion, applying passive or active torque, or electronically coordinating joint movement so as to produce a stable and repeatable object-engagement posture. A functional grasp pattern does not require full anatomical range of motion and may include assisted or augmented configurations that compensate for impaired neuromuscular control while enabling practical object use.

For purposes of the present disclosure, the term “hardware and/or software” refers to functions that may be performed by digital software, digital hardware, or a combination of both digital hardware and digital software. Various features of the present disclosure may be performed by hardware and/or software.

For purposes of the present disclosure, the term “individual” refers to an individual mammal, such as a human being.

For the purposes of the current invention, the term “linkage” refers a mechanical assembly comprising one or more interconnected rigid or semi-rigid members configured to transmit motion, force, or displacement between two or more components. A linkage may include pivot joints, sliding interfaces, pinned connections, cam interfaces, geared interfaces, cable-driven elements, or other mechanical couplings that convert, constrain, or coordinate movement. References to a linkage include four-bar linkages, articulated multi-link assemblies, motion-distribution bars, synchronized transmission members, or equivalent mechanisms capable of coordinating movement between one or more finger joints and a thumb joint. A linkage may convert linear motion to rotational motion, rotational motion to linear motion, or synchronize rotational movements across multiple axes. The term linkage is not limited to a particular geometric configuration and encompasses any mechanical structure configured to couple or coordinate motion among components of the exoskeleton.

For the purposes of the current invention, the term “linear actuator” refers a device configured to convert electrical, mechanical, or other input energy into substantially linear motion. A linear actuator may include, by way of example and not limitation, a motor-driven lead screw assembly, ball screw assembly, rack-and-pinion system, solenoid-based drive, or other electromechanical or mechanical mechanism capable of producing controlled linear displacement. References to actuation by a linear actuator include direct linear displacement of a linkage component as well as indirect conversion of linear motion into rotational or multi-link coordinated motion through a transmission mechanism. The linear actuator may operate under closed-loop or open-loop control and may be driven in response to sensor input, user interface commands, or stored program instructions.

For purposes of the present disclosure, the term “machine-readable medium” refers to any tangible or non-transitory medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” includes, but is limited to, solid-state memories, and optical and magnetic media. Specific examples of machine-readable media include non-volatile memory, including by way of example, semiconductor memory devices, e.g., EPROM, EEPROM, and flash memory devices; magnetic disks such as internal hard disks and removable disks; magneto-optical disks; and CD-ROM and DVD-ROM disks. The term “machine-readable medium” may include a single medium or multiple media (e.g., a centralized or distributed database, and/or associated caches and servers) that store the one or more instructions or data structures.

For the purposes of the present disclosure, the term “MEMS” refers to Micro-Electro-Mechanical Systems. MEMS, is a technology that in its most general form may be defined as miniaturized mechanical and electro-mechanical elements (i.e., devices and structures) that are made using the techniques of microfabrication. The critical physical dimensions of MEMS devices can vary from well below one micron on the lower end of the dimensional spectrum, all the way to several millimeters. Likewise, the types of MEMS devices can vary from relatively simple structures having no moving elements, to extremely complex electromechanical systems with multiple moving elements under the control of integrated microelectronics. A main criterion of MEMS may include that there are at least some elements having some sort of mechanical functionality whether or not these elements can move. The term used to define MEMS varies in different parts of the world. In the United States they are predominantly called MEMS, while in some other parts of the world they are called “Microsystems Technology” or “micromachined devices.” While the functional elements of MEMS are miniaturized structures, sensors, actuators, and microelectronics, most notable elements may include microsensors and microactuators. Microsensors and microactuators may be appropriately categorized as “transducers,” which are defined as devices that convert energy from one form to another. In the case of microsensors, the device typically converts a measured mechanical signal into an electrical signal.

For the purposes of the present disclosure the term “metacarpophalangeal joint” or “MCP joint” refers to the anatomical joint formed between a metacarpal bone of the hand and the proximal phalanx of a corresponding finger or thumb. In the fingers, the MCP joint permits flexion and extension, as well as varying degrees of abduction and adduction, thereby contributing to grasp formation. In the thumb, the metacarpophalangeal joint permits flexion and extension and contributes to pinch and grasp stabilization. References to movement or assistance at an MCP joint include any mechanical support, torque application, or actuation applied to influence flexion, extension, abduction, or adduction of the joint.

For purposes of the present disclosure, the term “non-transient storage medium” refers to a storage medium that is non-transitory, tangible and computer readable. Non-transient storage medium may refer generally to any durable medium known in the art upon which data can be stored and later retrieved by data processing circuitry operably coupled with the medium. A non-transitory, tangible, computer-readable storage medium may be capable of storing data, instructions, or information for use by, or in connection with, one or more processors or data-processing circuits. A non-transient storage medium permits the stored data to be accessed and retrieved at a later time and expressly excludes transitory forms of signal transmission, including propagating electromagnetic signals per se. A non-limiting non-exclusive list of exemplary non-transitory data storage media may include magnetic data storage media (e.g., hard disc, data tape, etc.), solid state semiconductor data storage media (e.g., SDRAM, flash memory, ROM, etc.), and optical data storage media (e.g., compact optical disc, DVD, etc.).

For the purposes of the present disclosure, the term “palmar” refers to the anterior surface of the hand corresponding to the palm, including the surface region extending from the base of the fingers to the wrist crease. The palmar surface is the surface typically used to contact and manipulate objects during grasping. When the specification describes the palmar surface as being “unobstructed” or “substantially unobstructed,” it means that no rigid structural component of the exoskeleton substantially interferes with direct object contact across the primary gripping region of the palm.

For the purposes of the present disclosure, the term “passive exoskeleton” refers to an exoskeleton that uses elastic components such as springs or elastic bands to apply force and torque to the body.

For the purposes of the present disclosure, the term “powered exoskeleton” refers to an exoskeleton that can be assistive or enhancing, and can help a user walk, lift heavy objects, improve flexibility, mobility or improve endurance. In some embodiments, the powered exoskeleton may be motor actuated and/or have a power source.

For purposes of the present disclosure, the term “processor” refers to a device that performs the basic operations in a computer. A microprocessor is one example of a processor.

For the purposes of the present disclosure, the term “proximal” refers to a position closer to the user’s wrist or closer to the user’s body along a given anatomical structure. With respect to the fingers, a proximal joint or segment is one that is nearer the hand or wrist relative to another joint or segment of the same finger. For example, the metacarpophalangeal joint is proximal relative to the proximal interphalangeal joint, and the proximal interphalangeal joint is proximal relative to the distal interphalangeal joint.

For the purposes of the present disclosure the term “proximal interphalangeal joint” or “PIP joint” refers to the anatomical hinge joint located between the proximal phalanx and the middle phalanx of a finger. The PIP joint primarily permits flexion and extension and contributes significantly to finger curvature during grasp formation. References to movement or assistance at a PIP joint include any mechanical support, torque application, resilient bias, or actuation configured to influence flexion or extension of the middle phalanx relative to the proximal phalanx. In embodiments of the present disclosure, assistance at the PIP joint may be passive, such as through spring biasing members, or active, such as through actuator-driven mechanisms.

For the purposes of the present disclosure, the term “random-access memory (RAM)” refers to a type of computer data storage. Today it takes the form of integrated circuits that allow the stored data to be accessed in any order, i.e. at random. The word random thus refers to the fact that any piece of data can be returned in a constant time, regardless of its physical location and whether or not it is related to the previous piece of data. This contrasts with storage mechanisms such as tapes, magnetic discs and optical discs, which rely on the physical movement of the recording medium or a reading head. In these devices, the movement takes longer than the data transfer, and the retrieval time varies depending on the physical location of the next item. The word RAM is mostly associated with volatile types of memory (such as DRAM memory modules), where the information is lost after the power is switched off. However, many other types of memory are RAM as well, including most types of ROM and a kind of flash memory called NOR-Flash.

For the purposes of the present disclosure, the term “read-only memory (ROM)” refers to a class of storage media used in computers and other electronic devices. Because data stored in ROM cannot be modified (at least not very quickly or easily), it is mainly used to distribute firmware (software that is very closely tied to specific hardware, and unlikely to require frequent updates). In its strictest sense, ROM refers only to mask ROM (the oldest type of solid state ROM), which is fabricated with the desired data permanently stored in it, and thus can never be modified. However, more modern types such as EPROM and flash EEPROM can be erased and re-programmed multiple times; they are still described as “read-only memory” because the reprogramming process is generally infrequent, comparatively slow, and often does not permit random access writes to individual memory locations.

For the purposes of the present disclosure, the term “real-time processing” refers to a processing system designed to handle workloads whose state is constantly changing. Real-time processing means that a transaction is processed fast enough for the result to come back and be acted on as transaction events are generated. In the context of a database, real-time databases are databases that are capable of yielding reliable responses in real-time. . For the purposes of the present disclosure, the term “router” refers to a networking device that forwards data packets between networks using headers and forwarding tables to determine the best path to forward the packets. Routers work at the network layer of the TCP/IP model or layer 3 of the OSI model. Routers also provide interconnectivity between like and unlike media devices. A router is connected to at least two networks, commonly two LANs or WANs or a LAN and its ISP’s network.

For the purposes of the present disclosure, the term “solid-state electronics” refers to those circuits or devices built entirely from solid materials and in which the electrons, or other charge carriers, are confined entirely within the solid material. The term is often used to contrast with the earlier technologies of vacuum and gas-discharge tube devices and it is also conventional to exclude electro-mechanical devices (relays, switches, hard drives and other devices with moving parts) from the term solid state. While solid-state can include crystalline, polycrystalline and amorphous solids and refer to electrical conductors, insulators and semiconductors, the building material is most often a crystalline semiconductor. Common solid-state devices include transistors, microprocessor chips, and RAM. A specialized type of RAM called flash RAM is used in flash drives and more recently, solid state drives to replace mechanically rotating magnetic disc hard drives. More recently, the integrated circuit (IC), the light-emitting diode (LED), and the liquid-crystal display (LCD) have evolved as further examples of solid-state devices. In a solid-state component, the current is confined to solid elements and compounds engineered specifically to switch and amplify it.

For purposes of the present disclosure, the term “storage medium” refers to any form of storage that may be used to store bits of information. Examples of storage media include both volatile and non-volatile memories such as MRRAM, MRRAM, ERAM, flash memory, RFID tags, floppy disks, Zip™ disks, CD-ROM, CD-R, CD-RW, DVD, DVD-R, flash memory, hard disks, optical disks, etc. Two or more storage media acting similarly to a single data storage medium may be referred to as a “storage medium” for the purposes of the present disclosure. A storage medium may be part of a computer.

For the purposes of the present disclosure, the term “time” refers to a component of a measuring system used to sequence events, to compare the durations of events and the intervals between them, and to quantify the motions of objects. Time is considered one of the few fundamental quantities and is used to define quantities such as velocity. An operational definition of time, wherein one says that observing a certain number of repetitions of one or another standard cyclical event (such as the passage of a free-swinging pendulum) constitutes one standard unit such as the second, has a high utility value in the conduct of both advanced experiments and everyday affairs of life. Temporal measurement has occupied scientists and technologists, and was a prime motivation in navigation and astronomy. Periodic events and periodic motion have long served as standards for units of time. Examples include the apparent motion of the sun across the sky, the phases of the moon, the swing of a pendulum, and the beat of a heart. Currently, the international unit of time, the second, is defined in terms of radiation emitted by cesium atoms.

For the purposes of the present disclosure, the term “timestamp” refers to a sequence of characters, denoting the date and/or time at which a certain event occurred. This data is usually presented in a consistent format, allowing for easy comparison of two different records and tracking progress over time; the practice of recording timestamps in a consistent manner along with the actual data is called timestamping. Timestamps are typically used for logging events, in which case each event in a log is marked with a timestamp. In file systems, timestamp may mean the stored date/time of creation or modification of a file. The International Organization for Standardization (ISO) has defined ISO 8601 which standardizes timestamps.

For the purposes of the present disclosure, the term “torque capacity” refers to the maximum level of torque that can be applied to the body segment.

For the purposes of the present disclosure, the term “visual display device” or “visual display apparatus” includes any type of visual display device or apparatus such as a CRT monitor, LCD screen, LEDs, a projected display, a printer for printing out an image such as a picture and/or text, etc. A visual display device may be a part of another device such as a computer monitor, television, projector, telephone, cell phone, smartphone, laptop computer, tablet computer, handheld music and/or video player, personal data assistant (PDA), handheld game player, head mounted display, a heads-up display (HUD), a global positioning system (GPS) receiver, automotive navigation system, dashboard, watch, microwave oven, electronic organ, automatic teller machine (ATM) etc.

For the purposes of the present disclosure, the term “wearable device” refers to a device that may be mounted, fastened or attached to a user or any part of a user’s clothing, or incorporated into items of clothing and accessories which may be worn on the body of a user. In some embodiments, wearable device refers to wearable technology, wearables, fashionable technology, tech togs, fashion electronics, clothing and accessories, such as badges, watches, and jewelry incorporating computer and advanced electronic technologies.

### Description

While the invention is susceptible to various modifications and alternative forms, specific embodiment thereof has been shown by way of example in the drawings and will be described in detail below. It should be understood, however that it is not intended to limit the invention to the particular forms disclosed, but on the contrary, the invention is to cover all modifications, equivalents, and alternatives falling within the spirit and the scope of the invention.

In certain implementations, the invention pertains to lightweight, low-profile, wearable hand exoskeleton devices configured to provide extension assistance and controlled grasp functionality through coordinated mechanical linkages, spring-based torque assistance, linear actuator systems, and integrated control electronics. The device architecture enables synchronized multi-digit movement while minimizing bulk and weight to facilitate comfortable, prolonged wear. The invention further encompasses systems incorporating force sensing for detection of user-generated effort, voluntary activation mechanisms, activity monitoring and performance logging capabilities, and wireless communication interfaces configured to communicate with external computing devices, including mobile applications, for therapeutic tracking, user feedback, and clinician oversight.

The invention is particularly well suited for rehabilitation and assistive applications involving individuals affected by stroke, spinal cord injury, cerebral palsy, arthritis, hand contracture, and other neuromuscular or musculoskeletal conditions resulting in impaired hand function. The device is configured for deployment in both supervised clinical environments and independent home-based settings, thereby enabling high-frequency task practice, longitudinal performance monitoring, and functional use during activities of daily living.

In one embodiment, a wearable hand exoskeleton device includes a dorsal support member configured to be positioned along the back of a user’s hand. The dorsal support member functions as a structural backbone supporting finger linkages, thumb linkages, actuation elements, sensing components, and control electronics while distributing loads across the metacarpal region. The device is arranged such that the palmar surface remains substantially unobstructed, thereby permitting direct object contact and natural tactile engagement during grasping and manipulation tasks. This dorsal-mounted configuration promotes functional usability while preserving the mechanical alignment necessary for coordinated joint assistance.

A plurality of finger assemblies are operatively coupled to respective fingers of the user such that movement of each assembly corresponds to movement of an associated anatomical digit. Each finger assembly includes one or more mechanical linkages positioned and oriented to align substantially with the anatomical axes of the corresponding finger joints, including at least the metacarpophalangeal joint and, in certain embodiments, the proximal interphalangeal joint. The linkages are configured to transmit force and displacement in a manner that substantially follows natural joint kinematics while minimizing misalignment and undesired shear forces.

A thumb assembly is operatively coupled to the thumb and is positioned to accommodate motion at the carpometacarpal joint, and optionally the metacarpophalangeal and interphalangeal joints of the thumb. The thumb assembly may include adjustable mounting features to align with individual anatomical variation and to permit natural abduction, adduction, flexion, and extension patterns.

The finger assemblies and thumb assembly are mechanically interconnected through a coupling mechanism configured to coordinate motion of the metacarpophalangeal joints of the fingers with motion of the carpometacarpal joint of the thumb. The coupling mechanism synchronizes digit movement such that flexion or extension of the fingers corresponds to complementary motion of the thumb, thereby producing controlled and repeatable multi-digit configurations. This coordinated movement enables formation of functional grasp patterns, including pinch-pad grasp and C-grasp configurations, as well as other cylindrical or spherical grasp postures suitable for engaging objects of varying size, shape, and stiffness.

The coupling mechanism may comprise a four-bar linkage, a multi-link articulated transmission, a cam-driven assembly, a cable-and-pulley arrangement, a gear train, a rack-and-pinion mechanism, a rigid synchronization bar, or any other mechanical transmission structure configured to coordinate motion among two or more digits. The coupling mechanism may convert linear displacement into rotational motion, synchronize rotational movement across multiple joints, or distribute motion from a single input source to multiple output linkages. The invention is not limited to a particular linkage geometry or topology, provided that the mechanism produces coordinated and repeatable multi-digit grasp motion.

In certain embodiments, coordinated flexion of the metacarpophalangeal joints of the fingers corresponds with complementary abduction or adduction of the thumb carpometacarpal joint to generate a pinch-pad grasp configuration. In other embodiments, additional degrees of freedom at one or more finger joints and/or thumb joints permit a C-grasp configuration, cylindrical grasp, spherical grasp, or other multi-digit posture suitable for engaging objects of varying size, shape, and compliance. The coupling mechanism may be configured to produce predetermined motion relationships or adjustable coordination ratios to accommodate different grasp requirements and user-specific anatomical or functional characteristics.

In a passively powered embodiment, extension assistance is generated by one or more resilient biasing members operatively coupled to the finger and/or thumb linkages. The resilient biasing members may include, by way of example and not limitation, steel coil springs, elastic bands, composite elastic elements, progressive-rate springs, or other energy storage components capable of producing a restoring force. The resilient biasing members are arranged and routed relative to the associated joint axes such that the effective moment arm varies throughout the range of motion. In certain configurations, the geometry of the routing path causes the effective lever arm to shorten as the fingers flex, thereby producing an extension torque that decreases with increasing flexion angle.

This decreasing torque profile reduces resistance to voluntary closing during object acquisition while still providing sufficient restorative force to assist reopening of the hand. By minimizing opposition to flexion at greater joint angles, the device promotes comfortable grasp formation and reduces muscular fatigue while preserving assisted extension capability.

The torque-angle relationship may be tailored through multiple design parameters, including modification of anchor positions, adjustment of wrap surfaces or cam interfaces, selection of springs having differing stiffness characteristics, alteration of effective spring length, incorporation of progressive or non-linear elastic elements, and modification of the routing geometry relative to the joint axes. Through such structural adjustments, the magnitude and profile of extension assistance may be tuned to accommodate varying user tone characteristics, range-of-motion limitations, and functional requirements.

Passive degrees of freedom may be incorporated at one or more proximal interphalangeal (PIP) joints of the fingers and at one or more thumb flexion and extension axes, including the carpometacarpal and/or metacarpophalangeal joints. These passive degrees of freedom permit independent or semi-independent motion of intermediate joints while maintaining coordinated overall grasp behavior. Resilient biasing members may be operatively coupled to these joints to provide extension assistance without substantially restricting flexion range. The biasing elements may be arranged such that restorative torque is applied in extension while allowing compliant flexion under voluntary effort.

The magnitude and profile of torque applied at the PIP joints and thumb joints may be selectively adjusted by altering effective spring length, selecting springs or elastic elements having differing stiffness characteristics, modifying routing geometry relative to joint axes, repositioning anchor points, or varying the number of biasing elements engaged. Through such configurability, assistance at individual joints may be tuned to accommodate differences in impairment severity, joint stiffness, or therapeutic objectives while preserving functional range of motion. The disclosed springs, elastic members, routing configurations, and associated mechanical interfaces provide the corresponding structural basis for providing extension assistance at these additional degrees of freedom.

The device may be configured to accommodate a range of hand sizes and anatomical variations through adjustable structural features. In certain embodiments, finger attachment points are extendable along the longitudinal axis of each finger assembly to correspond with varying phalangeal lengths. Distal interface components, such as rings or cuffs fabricated from compliant elastic material, may be secured to the digits using hook-and-loop fasteners or comparable adjustable fastening mechanisms. These distal attachment elements are configured to provide secure coupling between the exoskeleton linkage and the user’s finger while maintaining comfort and minimizing localized pressure.

Thumb attachment components may include rotational adjustment features permitting alignment with individual thumb orientation, including variations in abduction angle and carpometacarpal positioning. Adjustable mounting interfaces may allow fine tuning of thumb assembly orientation to optimize kinematic alignment and comfort.

Strap placement and tension may be selectively configured to prevent undesired finger curling, limit hyperflexion, or permit controlled flexion depending on therapeutic objectives. By positioning straps at selected anatomical locations, such as along the middle phalanx or near the proximal interphalangeal joint, the device can stabilize digit alignment while preserving functional range of motion. These adjustable structural features enhance fit customization, user comfort, and biomechanical alignment across a diverse patient population.

In an actively powered embodiment, at least one linear actuator is operatively coupled to the coupling mechanism such that linear displacement of the actuator produces coordinated motion of multiple finger joints and the thumb joint. In certain implementations, a single linear actuator is configured to drive simultaneous and mechanically synchronized movement of a plurality of fingers and the thumb through a shared transmission member. The shared transmission member may include, without limitation, a rigid linkage bar, an articulated linkage assembly, a cable distribution system, a gear train, a rack-and-pinion interface, or any equivalent motion-distribution structure configured to convert linear actuator displacement into coordinated rotational joint movement. The linear actuator may comprise a motor-driven lead screw assembly, ball screw assembly, or other electromechanical linear drive element capable of controlled bidirectional displacement. Linear motion generated by the actuator may be directly applied to the transmission member or converted into rotational or multi-axis motion through intermediate mechanical components. By employing a single actuator to coordinate multi-digit movement, the overall system architecture reduces mechanical complexity, minimizes component count, decreases weight and power consumption, simplifies control requirements, and enhances reliability relative to systems that utilize independent actuators for each individual finger.

A control system is integrated into the device and includes at least one processor operatively coupled to non-transitory memory storing executable program instructions, motor driver circuitry configured to supply controlled electrical power to the actuator, and an onboard power source such as a rechargeable battery enabling untethered operation. The processor is in electrical communication with the actuator, one or more sensors, user interface components, and a wireless communication module. In operation, the processor executes stored instructions to regulate actuator displacement, determine operating modes, interpret sensor inputs indicative of user-generated force or joint position, record rehabilitation metrics, and manage data transmission to external computing devices. The motor driver circuitry may implement closed-loop or open-loop control schemes, including proportional, threshold-based, or adaptive control algorithms, to modulate actuator output. The integration of the processor, memory, motor driver circuitry, and power source provides the structural foundation for actuator control, intent detection, data logging, and wireless communication functions, and constitutes the corresponding structure for computer-implemented and actuation-related claim elements.

A force sensor, strain gauge, load cell, flex sensor, or equivalent force- or deformation-responsive sensing element may be integrated into a finger linkage, transmission member, actuator interface, or other mechanical component positioned to detect user-generated flexion effort. The sensing element may be configured to measure compressive, tensile, bending, or shear forces transmitted through the linkage during attempted finger motion. Sensor signals are communicated to the processor, which executes an intent-detection algorithm stored in non-transitory memory. The algorithm may compare sensed force magnitude to one or more predetermined or adaptive threshold values, evaluate rate of change of force over time, apply filtering to reduce signal noise, analyze temporal patterns indicative of voluntary contraction, and differentiate active user effort from passive movement, spasticity, or externally imposed forces. Upon satisfaction of a defined activation criterion, the control system commands the motor driver circuitry to actuate the linear actuator to provide assistive torque in flexion or extension according to a selected operational mode. The level of assistance may be binary, proportional to sensed force, or adaptively scaled based on stored performance metrics. The disclosed sensing elements and associated processing logic provide the corresponding structure for detecting user-generated force and determining user intents.

The device may further include a user interface configured to permit manual selection and control of operational modes. The user interface may comprise, by way of example and not limitation, a slider potentiometer, a force-open/force-close mechanical switch, a push-button switch, a rotary selector, a capacitive or resistive touchscreen display, or a wireless remote interface communicating with the control system. The user interface is operatively coupled to the processor such that user inputs are interpreted as control commands for modifying actuator behavior, selecting assistance profiles, or initiating therapy sessions.

In certain embodiments, a force-open mode and a force-close mode are selectable, thereby permitting the user to command the device to actively assist hand opening or hand closing independent of force-sensor activation. In other embodiments, the slider potentiometer provides proportional control input, allowing graded actuator activation based on slider position. The slider control may be positioned and configured to permit activation using a contralateral, less-affected hand, thereby enabling users with minimal residual function in the impaired hand to initiate or override device operation. The user may select among operating modes based on impairment severity, therapeutic goals, fatigue level, or task requirements. These user interface components provide structural support for selectable operational modes and manual control features recited in the claims.

Position sensors, such as rotary encoders, linear encoders, Hall-effect sensors, potentiometric position sensors, or other displacement-sensing elements, may be operatively coupled to one or more joints or linkage members to measure joint displacement and motion state during device operation. The sensors are configured to sample positional data at a frequency sufficient to capture clinically relevant rehabilitation metrics, and in certain embodiments may operate at sampling rates of at least approximately 20–30 Hz or greater to provide accurate tracking of grasp and release cycles. Sensor outputs are communicated to the processor, which computes and records parameters including joint angle, angular velocity, range of motion, repetition count, session duration, grip amplitude, and other performance indicators. The recorded data are stored in non-transitory memory associated with the control system and may be retained locally for later retrieval or transmitted in real time or batch mode via the wireless communication module to an external computing device for monitoring, analysis, or therapeutic feedback.

A wireless communication module may be integrated into the control electronics and operatively coupled to the processor through the printed circuit board. The wireless communication module may include, by way of example and not limitation, a Bluetooth transceiver, Wi-Fi interface, cellular communication chipset, near-field communication (NFC) device, or other radio-frequency transceiver configured for short-range or long-range data transmission. The module may support encrypted data exchange and bidirectional communication between the exoskeleton device and one or more external computing devices.

In operation, performance data stored in non-transitory memory may be transmitted to a remote computing device, such as a smartphone, tablet, laptop, or cloud-based server system, executing a software application configured to display usage metrics, generate therapy progress indicators, track compliance, and enable clinician review. The application may further provide interactive training programs, gamified rehabilitation exercises, performance feedback, and configurable assistance settings. Bidirectional communication may permit remote adjustment of therapy parameters, firmware updates, or calibration settings, thereby enhancing device adaptability and facilitating longitudinal rehabilitation management.

The device is secured along the dorsal side of the user’s hand such that the finger assemblies and thumb assembly are aligned with the corresponding anatomical joints. Once positioned, extension assistance is applied to one or more finger joints and, in certain embodiments, to the thumb joint through passive resilient biasing members and/or active actuator-driven torque. The applied assistance biases the digits toward extension while permitting voluntary flexion by the user.

To initiate grasp, the user voluntarily flexes the fingers and thumb against the provided extension assistance. In embodiments incorporating a decreasing torque profile, resistance to flexion diminishes as the digits close, thereby facilitating object acquisition and reducing fatigue. Upon release, assisted reopening of the hand occurs either through passive spring bias returning the joints toward extension or through controlled actuator displacement in actively powered embodiments.

Assistance parameters, including but not limited to torque magnitude, activation thresholds, actuator speed, displacement limits, operating modes, and control profiles, may be selectively adjusted through user input received via the user interface or automatically modified by the control system in response to recorded performance data. In certain embodiments, the processor executes adaptive control algorithms that analyze stored rehabilitation metrics, such as range of motion, repetition count, applied force levels, task duration, or rate of improvement, and dynamically modify assistance levels accordingly. Adjustment may occur in real time during a therapy session or between sessions based on longitudinal performance trends. Such adaptive modulation enables the device to accommodate variations in muscle tone, strength capacity, fatigue state, and stage of recovery, thereby providing assistance that is appropriately scaled to the user’s functional capability. Through controlled and responsive adjustment of assistance parameters, the device supports both immediate functional object manipulation and progressive therapeutic training individualized to the user’s rehabilitation objectives.

In computer-implemented embodiments, executable program instructions stored in non-transitory memory are executed by the processor to perform a sequence of control and monitoring operations. These operations include receiving and conditioning sensor input signals, evaluating the signals to determine user intent, generating control commands to drive the actuator so as to provide assistive torque, recording rehabilitation-related metrics, and transmitting collected data via the wireless communication module. The executable instructions may implement threshold-based activation logic, proportional or gain-adjusted control schemes, closed-loop position or force control, adaptive torque modulation algorithms, and session-based therapy tracking functions. The software architecture may further include filtering routines, error detection and correction logic, safety interlocks, and calibration procedures to ensure reliable and responsive device operation. Together, the processor and the stored executable instructions provide the structural and functional framework for computer-implemented control of the exoskeleton system.

Passive and active components may be integrated in hybrid configurations to provide scalable functionality across varying levels of user impairment. In certain embodiments, a primarily passive mechanical exoskeleton may be configured with mounting provisions and electrical interfaces that permit modular addition of electronic components, including an actuator assembly, control circuitry, sensors, and a wireless communication module. Such modular architecture allows a base passive device to be upgraded to an actively powered and data-enabled configuration without substantial redesign of the underlying mechanical structure. Conversely, actively powered embodiments may incorporate passive resilient biasing members to reduce actuator load and improve energy efficiency.

Structural components of the device may be fabricated from lightweight and durable materials including polymer composites, engineering-grade thermoplastics, reinforced polymers, metal alloys, or combinations thereof. Additive manufacturing techniques, such as three-dimensional printing, may be employed to produce customized geometries or patient-specific components. Resilient biasing members, including springs or elastic elements, may be enclosed or shielded within protective housings to reduce wear, prevent contamination, and enhance long-term durability. Material selection and structural design may be optimized to minimize overall device weight while maintaining sufficient rigidity and fatigue resistance for repeated therapeutic use. For example, in some embodiments, the disclosed device may be designed to weigh between approximately .316 and .451 kilograms.

The system, as described in the present technique or any of its components, may be embodied in the form of a computer system. Typical examples of a computer system includes a general-purpose computer, a programmed micro-processor, a micro-controller, a peripheral integrated circuit element, and other devices or arrangements of devices that are capable of implementing the steps that constitute the method of the present technique.

The computer system comprises a computer, an input device, a display unit and/or the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present technique. The set of instructions may be in the form of a software program. Further, the software may be in the form of a collection of separate programs, a program module with a larger program or a portion of a program module, as in the present technique. The software may also include modular programming in the form of object-oriented programming. The processing of input data by the processing machine may be in response to user commands, results of previous processing or a request made by another processing machine.

Having described the many embodiments of the present disclosure in detail, it will be apparent that modifications and variations are possible without departing from the scope of the invention defined in the appended claims. Furthermore, it should be appreciated that all examples in the present disclosure, while illustrating many embodiments of the invention, are provided as non-limiting examples and are, therefore, not to be taken as limiting the various aspects so illustrated.

### EMBODIMENTS OF THE HAND EXOSKELETON SYSTEM

### HandSOME I

In a first disclosed embodiment, the HandSOME I comprises a passively powered wearable hand exoskeleton configured to provide assistive and rehabilitative support to individuals experiencing impaired hand function, including impairment resulting from stroke. The device employs a mechanically coupled linkage architecture that coordinates movement of the fingers and thumb to generate functional grasp patterns while providing controlled extension assistance through resilient biasing elements. Unlike conventional passive orthotic devices that rely on direct spring attachment to individual digits, the HandSOME I incorporates a coordinated mechanical transmission that synchronizes multi-digit motion and shapes the torque profile applied across the range of motion. This mechanically integrated coupling design enables functional grasp assistance while preserving substantial voluntary flexion capability, thereby supporting both daily task performance and therapeutic rehabilitation.

Several commercially available and developmental devices have sought to address impaired hand function, yet each exhibits structural or functional limitations that constrain performance. For example, the SaeboFlex device (Saebo, Inc., Charlotte, NC) is a passive hand rehabilitation orthosis that provides extension bias to assist hand opening. While conceptually similar in providing spring-based assistance, the SaeboFlex is primarily directed toward tone management and repetitive opening exercises rather than enabling a broad range of functional grasp configurations. The device architecture is configured such that effective object acquisition is generally limited to relatively large cylindrical objects, and smaller or irregularly shaped objects may not be readily grasped due to restricted multi-joint articulation and limited thumb coordination. A subsequent product, the SaeboGlove, introduces additional degrees of freedom and increased flexibility; however, its design is typically suited for individuals with mild impairment and may not provide sufficient assistance for users with more significant motor deficits.

The Armeo Spring system provides upper limb support and incorporates a tensioning mechanism that delivers assistance at the metacarpophalangeal joints. Although it introduces adjustable MCP extension assistance, it does not provide a compact, low-profile wearable architecture optimized for unobstructed palmar interaction during daily object manipulation, nor does it fully address coordinated multi-joint finger-thumb coupling in a hand-worn exoskeleton form factor.

Other devices, such as linear motor-powered glove systems, including the MotusNova system, employ active actuation to assist finger movement. However, certain implementations lack integrated thumb support or coordinated thumb-finger coupling necessary to generate stable functional grasp patterns. The absence of synchronized thumb articulation may limit the ability to perform pinch-based or multi-digit grasp tasks essential for many activities of daily living.

Accordingly, while prior devices provide various forms of passive or active assistance, limitations remain in achieving coordinated multi-digit grasp, accommodating diverse object geometries, supporting users with moderate to severe impairment, and maintaining a lightweight, wearable architecture suitable for functional daily use.

Other versions of disclosed embodiments for HandSOME and published several papers on the device have been developed including: Casas R, Sandison M, Chen T, Lum PS. Clinical Test of a Wearable, High DOF, Spring Powered Hand Exoskeleton (HandSOME II). IEEE Trans Neural Syst Rehabil. 2021;29:1877-1885; Casas R, Sandison M, Nichols D, Martin K, Phan K, Chen T and Lum PS (2021) Home-Based Therapy After Stroke Using the Hand Spring Operated Movement Enhancer (HandSOME II). Front. Neurorobot. 15:773477. doi: 10.3389/fnbot.2021.773477; Chen J, Nichols D, Brokaw EB, Lum PS. Home-Based Therapy After Stroke Using the Hand Spring Operated Movement Enhancer (HandSOME). IEEE Trans Neural Syst Rehabil Eng. 2017 Dec;25(12):2305-2312; Brokaw EB, Black I, Holley RJ, Lum PS (2011) Hand Spring Operated Movement Enhancer (HandSOME): A Portable, Passive Hand Exoskeleton for Stroke Rehabilitation. IEEE Transactions on Neural Systems and Rehabilitation Engineering 19(4):391-9.

In earlier iterations of the HandSOME I design, certain structural and functional limitations were observed. The prior configuration exhibited a comparatively bulky dorsal profile, which reduced wearability and aesthetic acceptability for extended daily use. The available grasp configurations were limited, and the tension adjustment mechanism relied on manual engagement of elastic bands at upper mounting locations, which could be cumbersome for users with impaired dexterity and did not permit fine adjustment of the torque profile.

In particular, the earlier design did not provide extension assistance at the proximal interphalangeal (PIP) joints and did not incorporate an independent or coupled degree of freedom (DOF) at those joints. As a result, finger curvature during grasp formation was constrained, limiting the ability to form more natural C-grasp or spherical grasp patterns. Additionally, the absence of a PIP coupling mechanism prevented coordinated multi-joint articulation that more closely replicates physiological finger motion.

Accommodation of varying finger lengths in the earlier design was achieved primarily through placement of hook-and-loop fastener straps in predefined slots along the dorsal structure. This arrangement provided limited adjustability and did not fully accommodate anatomical variation across users. Furthermore, the strap-slot configuration restricted distal extension of the fingertips, potentially limiting full range of motion and reducing effectiveness in certain grasp tasks.

The improvements described herein address these limitations by providing enhanced adjustability, additional degrees of freedom, and more refined torque control across the range of motion.

Compared to earlier iterations of the HandSOME I design, the updated mechanical architecture incorporates several structural and functional enhancements that address previously identified limitations. The revised design introduces an additional degree of freedom (DOF) at the proximal interphalangeal (PIP) joint, together with adjustable extension assistance at that joint. This added articulation permits improved finger curvature during grasp formation and enhances the ability to conform to objects of varying shapes and sizes.

The updated design further provides a configurable coupling mechanism at the PIP joint, enabling coordinated multi-joint motion that supports formation of a C-grasp posture. By permitting controlled articulation of both the metacarpophalangeal and proximal interphalangeal joints, the device more closely replicates physiological grasp kinematics and expands the range of functional grasp patterns available to the user.

A refined tension-tightening mechanism is incorporated to facilitate more convenient and precise adjustment of extension assistance. In certain embodiments, adjustable tensioning elements are provided at the metacarpophalangeal joint in a manner similar to tension-adjustment approaches used in other upper limb assistive systems, while maintaining a compact hand-worn architecture. This improved tensioning system allows users or clinicians to modify assistance levels without requiring complex manual reconfiguration of elastic elements.

The updated device architecture also reduces overall bulk and profile, resulting in a more compact, low-profile configuration that improves wearability, comfort, and aesthetic acceptability during extended use. Structural components are arranged to minimize dorsal protrusion while maintaining mechanical integrity and joint alignment.

Extension assistance is further extended to the thumb joint, including assistance at the carpometacarpal joint and, in certain embodiments, additional thumb axes. Providing thumb-specific assistance enhances stability during pinch and multi-digit grasp configurations and supports improved functional manipulation.

In addition, the updated design may incorporate an integrated visual display, such as an LED-based indicator or display module, configured to present operational status, usage metrics, or therapy feedback directly on the device. The system may further include wireless communication capabilities enabling communication with a mobile application. Through such communication, performance data may be transmitted for monitoring, analysis, and user engagement, thereby supporting both assistive functionality and structured rehabilitation programs.

The incorporation of controlled motion at the proximal interphalangeal (PIP) joints of the fingers and flexion/extension capability at the thumb carpometacarpal (CMC) joint substantially enhances grasp versatility. By permitting articulation at these additional degrees of freedom, the device enables more anatomically natural finger curvature and thumb positioning during object engagement. This expanded articulation supports formation of flexible grasp patterns capable of conforming to objects of varying geometry, including round, spherical, cylindrical, and irregularly shaped items. The enhanced motion is achieved, in certain embodiments, through the addition of passive spring-powered assistance at the PIP joints and thumb flexion/extension axes, thereby providing restorative extension torque while preserving substantial voluntary flexion range.

To accommodate anatomical variability among users, the device incorporates adjustable structural interfaces. Finger and thumb attachment points may be longitudinally extendable to correspond with individual finger lengths, thereby improving kinematic alignment between the exoskeleton linkages and the underlying joints. The thumb attachment component may include rotational adjustment features permitting alignment with the user’s native thumb orientation, including variations in abduction angle and CMC positioning.

Each finger assembly may include an adjustable distal ring fabricated from a compliant material, such as elastic nylon, secured by hook-and-loop fasteners or equivalent fastening mechanisms. This configuration facilitates secure coupling while enabling simplified donning and doffing. Strap placement is strategically configurable to optimize joint alignment and functional performance. Straps may be positioned distally along the middle phalanx or aligned near the PIP joint to prevent undesired finger curling while preserving flexion capability. The thumb strap, similarly formed from compliant material, may be selectively adjusted to either restrict excessive thumb flexion or permit controlled motion, and may be positioned near the thumb interphalangeal (IP) joint to promote proper alignment and stability.

In contrast to certain commercially available passive devices that employ springs directly attached to the fingers, resulting in extension torque that increases with increasing flexion and thereby impedes voluntary closing, the present design routes spring forces through a coordinated linkage system. By transmitting spring force through a mechanical linkage, the applied extension torque may be shaped to decrease throughout the flexion arc, enabling greater functional range of motion and reducing fatigue in the flexor musculature. This mechanically mediated torque profile allows users to achieve and maintain deeper flexion during grasp tasks while still benefiting from assisted reopening, thereby expanding functional utility beyond that achievable with direct spring attachment configurations.

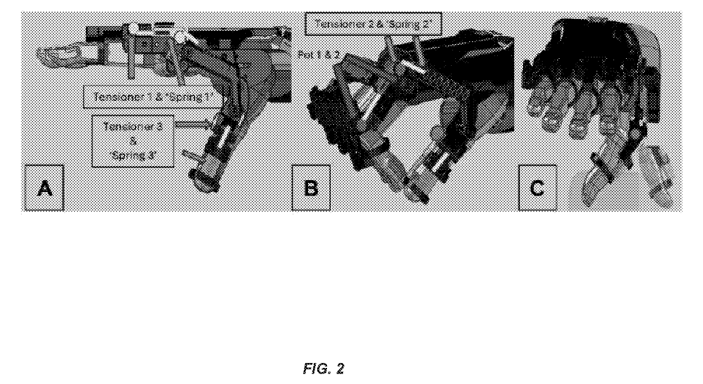

In one exemplary embodiment, the device incorporates a four-bar linkage architecture configured to coordinate movement at the metacarpophalangeal (MCP) joints of the fingers with movement at the carpometacarpal (CMC) joint of the thumb. The linkage configuration is inspired by single-degree-of-freedom prosthetic gripper mechanisms and is adapted to reproduce coordinated pinch-pad grasp (e.g., FIG. 2B) kinematics consistent with functional hand use. Through this mechanically synchronized arrangement, flexion and extension of the fingers are coupled with complementary thumb motion to generate a repeatable and anatomically aligned grasp pattern.

The device provides extension assistance through resilient biasing elements routed through the linkage mechanism such that applied extension torque decreases as the digits flex. This decreasing torque profile permits a large functional range of motion during grasp formation, facilitating engagement of objects while reducing resistance at greater flexion angles. The magnitude of extension assistance may be adjusted by varying the number of elastic cords or springs engaged, and the torque-angle profile may be shaped by modifying the routing path of the resilient elements relative to the joint axes. By altering the effective moment arm of the biasing members throughout the range of motion (ROM), the torque profile can be tailored to the needs of individual users.

An integrated position sensor, such as an encoder, is operatively coupled to one or more linkage members to record joint displacement data. In certain embodiments, position data may be sampled at a frequency of approximately 30 Hz or greater, thereby enabling accurate tracking of movement cycles and supporting quantitative monitoring of rehabilitation performance.

In certain configurations, the MCP joints of the fingers are mechanically coupled to thumb CMC adduction and abduction, thereby producing a pinch-pad grasp pattern. In more advanced embodiments, additional degrees of freedom are incorporated at the finger proximal interphalangeal (PIP) joints and at the thumb CMC flexion and extension axes. By permitting motion at these additional joints, the device enables more flexible grasp patterns, including C-grasp and spherical grasp configurations suitable for engaging round or irregularly shaped objects. Passive spring-powered assistance may be applied at these additional degrees of freedom to provide restorative extension torque while preserving substantial voluntary flexion capability.

In an electronically enhanced embodiment, control electronics are integrated to enable tetherless, battery-powered operation. A printed circuit board is designed to support a processor, motor driver circuitry, power management components, and a wireless communication module. A rechargeable battery is incorporated to permit untethered use during daily activities and home-based therapy. A user interface may be provided to display activity progress and operational status, including visual indicators of usage metrics.

An advanced version of the device may incorporate expanded logging and interactive functionality, providing movement data recording, performance tracking, and gamified training interfaces to motivate user engagement. Such embodiments support longitudinal monitoring and personalized therapy adjustment while preserving the underlying mechanical functionality of the base device. A modular architecture permits offering a mechanically focused configuration emphasizing accessibility and cost efficiency, as well as an electronically enhanced configuration providing advanced monitoring and adaptive control capabilities. Together, these embodiments enable scalable deployment across a wide range of clinical and home-based rehabilitation contexts while maintaining mechanical simplicity and functional effectiveness.

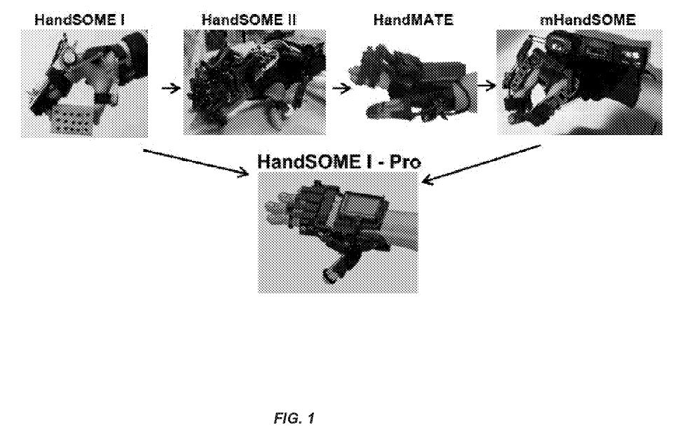

FIG. 1 illustrates the evolutionary progression of the disclosed hand exoskeleton systems from purely passive mechanical embodiments to actively powered configurations. The figure presents representative embodiments of devices within the HandSOME family and the subsequent motorized HandMate system to demonstrate architectural development and functional expansion. The HandSOME I and mHandSOME share structural design coupling movement of all fingers and thumb into one degree of freedom (DOF).

In the illustrated embodiments, the earlier HandSOME I configuration is depicted as a passively powered wearable exoskeleton employing mechanically coupled linkages and resilient biasing members to assist coordinated grasp. The mechanical architecture couples movement of all fingers and the thumb into a single coordinated degree of freedom (DOF), such that flexion and extension of the digits occur in a synchronized manner. This single-DOF configuration simplifies mechanical complexity while enabling repeatable pinch-pad and functional grasp patterns.

The figure further illustrates the mHandSOME embodiment, which retains the underlying structural architecture of coordinated multi-digit coupling into a single DOF while incorporating additional refinements such as enhanced tension control and modular adaptability. Like HandSOME I, the mHandSOME configuration mechanically couples movement of the fingers and thumb to preserve synchronized grasp formation.

Also depicted is the motorized HandMate embodiment, which represents an actively powered evolution of the mechanical architecture. In this configuration, actuation elements are integrated to provide powered assistance while maintaining coordinated multi-digit motion. The progression illustrated in FIG. 1 demonstrates the transition from passive spring-assisted mechanisms to actuator-driven systems while preserving the core design principle of mechanically coupling the fingers and thumb into a unified degree of freedom to generate functional grasp patterns.

FIG. 2 illustrates representative views of the enhanced configuration incorporating additional passive degrees of freedom. FIG. 2A depicts a side view of the device illustrating the relative positioning of the finger and thumb linkages and associated resilient biasing members. FIG. 2B provides an angled perspective view demonstrating the C-grasp pattern achievable through incorporation of the additional PIP degree of freedom. FIG. 2C presents a front view of the thumb assembly, showing the thumb position in the current prototype configuration in a darker shading and the modified thumb trajectory enabled by the newly incorporated degree of freedom in a lighter shading.

In an exemplary embodiment illustrated in FIG. 2, the device incorporates two additional passive spring-assisted degrees of freedom (DOF) to enhance extension assistance and enable more natural grasp kinematics. The illustrated configuration includes a passive degree of freedom (DOF) at each finger proximal interphalangeal (PIP) joint and a passive degree of freedom at the thumb carpometacarpal (CMC) flexion and extension axis. These additional articulations are configured with adjustable tension controls to permit individualized tuning of extension assistance at each joint.

In this embodiment, movement of the metacarpophalangeal (MCP) joints of the four fingers and thumb abduction and adduction are mechanically coupled through a linkage mechanism such that coordinated motion is produced from a shared input. As a result of this coordinated architecture, a single resilient biasing member, identified as spring 2 in the illustrated configuration, may provide extension assistance to both the finger MCP joints and thumb abduction movement. By coupling these motions through a shared linkage, the number of required biasing elements is reduced while maintaining synchronized multi-digit coordination.

The additional passive PIP degree of freedom, assisted by a separate resilient biasing member identified as spring1, enables increased finger curvature during flexion. This added articulation allows formation of a more flexible C-grasp configuration, thereby expanding the range of objects that can be engaged, including round or spherical items. Spring1 provides restorative extension torque at the PIP joint while preserving substantial voluntary flexion capability.

A further passive degree of freedom, assisted by an additional resilient biasing member identified as spring 3, is incorporated to assist thumb extension at the CMC flexion and extension axis. Although the coordinated MCP and thumb abduction assistance provided by spring 2 is sufficient to generate functional grasp patterns, the addition of passive thumb flexion and extension motion permits a more anatomically natural thumb trajectory. This configuration enhances comfort and alignment, particularly for users exhibiting stiffness or restricted mobility at the thumb CMC joint. By allowing controlled thumb flexion and extension independent of abduction and adduction, the device accommodates anatomical variability and improves ergonomic compatibility during sustained use.

Together, the incorporation of passive PIP assistance, thumb CMC flexion and extension assistance, and coordinated MCP-thumb coupling produces a mechanically efficient architecture capable of generating versatile grasp patterns while maintaining adjustable and user-specific extension support.

In the illustrated embodiment of FIG. 2, yellow lines indicate representative routing paths of the resilient biasing members. These spring paths may be selectively adjusted using tensioning knobs or equivalent adjustment mechanisms to vary extension torque magnitude and torque-angle profile. Purple arrows in the figure identify potentiometers or equivalent position-sensing elements disposed proximate the metacarpophalangeal (MCP) and proximal interphalangeal (PIP) joint axes. These sensors are configured to measure angular displacement at the respective joints to support movement monitoring and control functions.

As illustrated, the resilient biasing member identified as “spring 2” provides extension assistance to the MCP joints of the fingers and abduction assistance to the thumb carpometacarpal (CMC) joint. Although “spring 2” is depicted as externally exposed in the side view for clarity of illustration, the disclosed design contemplates positioning the spring within a protected region between the coupling structure and the thumb base. Such internal placement improves protection, reduces snagging risk, enhances durability, and maintains a streamlined external profile while preserving the mechanical function of coordinated multi-digit extension assistance.

In the illustrated embodiment, small steel coil springs are operatively coupled to provide extension torque at the metacarpophalangeal (MCP), proximal interphalangeal (PIP), and carpometacarpal (CMC) joints. The springs are arranged such that the user may voluntarily flex the associated joints against the restorative bias of the springs, thereby enabling controlled grasp formation while maintaining assisted reopening. Adjustment mechanisms, such as tensioning knobs or equivalent threaded or cam-based devices, permit modification of the effective spring length and corresponding torque magnitude. By tightening or loosening the adjustment mechanism, the preload and effective extension assistance may be selectively varied to accommodate individual user requirements.

A range of spring types may be utilized, including commercially available coil springs of differing wire diameters, coil counts, and stiffness constants. Selection of spring characteristics allows customization of extension torque magnitude and profile. In alternative embodiments, elastic bands or other resilient members may be employed in place of or in combination with coil springs. Elastic bands may provide advantages including reduced weight, simplified replacement, and ease of stiffness customization. The choice between coil springs and elastic elements may be determined based on durability requirements, weight constraints, desired torque characteristics, or user preference.

Prior testing has demonstrated that steel coil springs can maintain consistent performance over extended training periods without measurable degradation. To enhance longevity and reliability, resilient biasing members may be partially or fully enclosed within protective housings or shielded by structural elements to reduce exposure to debris, moisture, or mechanical wear. In certain configurations, the anchor point of the spring or the routing path around guide surfaces may be modified to alter the effective moment arm relative to the joint axis. Adjusting anchor positions, incorporating wrap surfaces, or changing routing geometry modifies the torque-angle relationship applied across the range of motion.

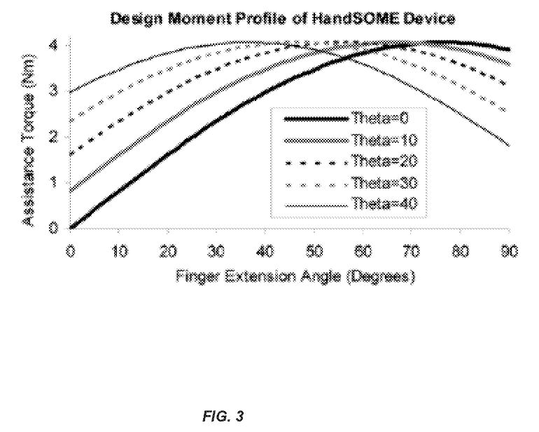

FIG. 3 illustrates representative torque-angle profiles generated by varying anchor positions of the resilient biasing members used to provide extension assistance. The horizontal axis represents finger extension angle, with zero degrees corresponding to a fully closed hand position. Increasing angular values correspond to progressive extension of the fingers toward an open-hand posture. The vertical axis represents the magnitude of extension torque applied at the associated joint.

The figure depicts multiple torque curves corresponding to different anchor point configurations, represented by a variable parameter theta. When theta equals zero, the spring follows a default routing path. In this configuration, the applied extension torque is greatest when the hand is in a more open position and progressively decreases as the hand moves toward a closed position. This decreasing torque profile facilitates voluntary grasp formation by reducing resistance during finger flexion while still assisting reopening.

As the value of theta increases, corresponding to modified anchor positions or altered spring routing geometry, the torque profile shifts such that greater extension torque is applied when the hand approaches or reaches the fully closed position. Higher theta values therefore increase the restorative force available at smaller extension angles. This configuration may be beneficial for users who experience difficulty reopening the hand after closure, as additional torque is available to overcome flexor tone or stiffness in the closed position.

FIG. 3 thus demonstrates that modification of spring anchor geometry allows shaping of the torque-angle relationship across the range of motion. By selecting appropriate anchor configurations, the extension assistance profile may be tuned to match individual user tone characteristics, strength capacity, and rehabilitation objectives.

As illustrated in FIG. 3, altering the spring routing path can produce distinct torque profiles at full extension and at full flexion. For example, routing configurations may be selected to increase extension torque at greater flexion angles for users who experience difficulty reopening the hand after closure. In other configurations, the torque profile may be shaped to decrease progressively with increasing flexion, thereby reducing resistance during grasp formation and facilitating object acquisition during task practice. By providing configurable torque-angle profiles, the device can be tuned to match the tone characteristics, strength capacity, and rehabilitation goals of individual users. Such individualized tuning may maximize functional range of motion, improve grip strength within the assisted configuration, and enhance overall therapeutic effectiveness.

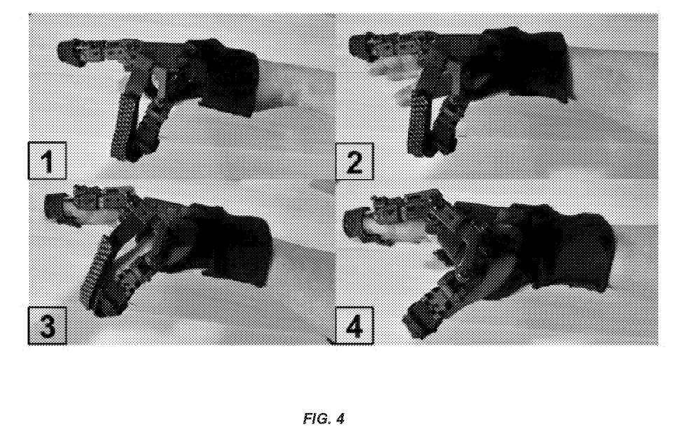

FIG. 4 illustrates an exemplary sequence of a donning procedure for the wearable hand exoskeleton according to one embodiment of the present disclosure. The sequence demonstrates how the device may be positioned, secured, and adjusted on a user’s hand to achieve proper anatomical alignment and functional readiness.

In an initial step, the dorsal support structure is positioned along the back of the user’s hand such that the finger assemblies and thumb assembly are aligned with the corresponding anatomical joints. The device is oriented so that the palmar surface of the hand remains substantially unobstructed. In a subsequent step, the finger attachment elements, including distal rings or cuffs, are positioned over the respective fingers and secured using adjustable fastening mechanisms such as hook-and-loop straps. The adjustable features allow the attachment points to be aligned with individual finger lengths and joint axes.

The thumb assembly is then positioned and secured to the thumb. Rotational adjustment of the thumb attachment component may be performed to align with the user’s natural thumb orientation and carpometacarpal joint position. A thumb strap may be secured near the interphalangeal joint to stabilize alignment while permitting controlled motion as required.

In a further step, tension adjustment mechanisms associated with resilient biasing members may be set to an appropriate assistance level. Adjustment may be performed using tensioning knobs or equivalent mechanisms to tailor extension torque magnitude to the user’s needs. If the device includes active actuation components, the control system may be powered on and operating mode selected via the user interface.

The illustrated sequence demonstrates that the device may be donned in a structured and repeatable manner, enabling proper alignment of mechanical linkages with anatomical joints while facilitating user comfort and functional readiness for therapeutic or assistive use.

Accordingly, in an exemplary sequence of steps for donning the hand exoskeleton device onto a user’s hand, in Step 1, the user may initially position the device adjacent to the dorsal side of the hand and wrist while the wrist support cuff remains open. The hand is inserted beneath the wrist strap such that the dorsal portion of the hand aligns with the primary support frame of the device. At this stage, the thumb remains outside the thumb-actuation linkage, and the device is loosely supported against the back of the hand.

In Step 2, the user may advance the hand further into the device so that the thumb approaches the thumb engagement structure located at the distal portion of the exoskeleton frame. The wrist cuff begins to wrap around the wrist, providing preliminary stabilization while the mechanical linkage system remains positioned above the thumb.

In Step 3, the user may insert the thumb into the thumb interface or engagement pad located at the distal end of the articulated linkage assembly. The thumb is guided beneath the distal linkage segment so that the thumb pad or cap aligns with the thumb tip. At this stage, the thumb becomes mechanically coupled with the linkage mechanism that enables assisted thumb flexion and extension.

In Step 4, the user may secure the wrist cuff firmly around the wrist, thereby stabilizing the exoskeleton frame relative to the hand. Once the wrist strap is tightened, the linkage assembly is properly aligned with the thumb joints and the device is ready for operation. The secured configuration ensures that actuation forces transmitted through the linkage system correspond to the natural movement axis of the thumb during therapeutic or assistive operation.

Accordingly, the illustrated sequence enables rapid, intuitive, and self-administered donning of the exoskeleton device while ensuring proper mechanical alignment between the device’s articulated linkage system and the user’s thumb anatomy.

### mHandSOME

In a second disclosed embodiment, the mHandSOME comprises an actively powered wearable hand exoskeleton incorporating a linear actuator-based drive system. The device is configured to provide controlled, assistive movement of the fingers and thumb for individuals experiencing impaired hand function due to stroke, neurological injury, musculoskeletal injury, or other neuromotor conditions. The mHandSOME embodiment is designed to function both as a rehabilitative training device that supports recovery of motor function and as an immediate assistive device that augments grasp capability during activities of daily living.

The mHandSOME system integrates a linear actuator with a coordinated mechanical coupling architecture that synchronizes multi-digit motion while minimizing mechanical complexity. The actuation method is configured to translate linear displacement into coordinated rotational movement of multiple finger joints and the thumb through a shared transmission mechanism. This architecture permits multi-digit assistance using a reduced number of actuators relative to independently driven finger systems, thereby lowering part count, weight, and control overhead while preserving functional grasp capability. The combination of linear actuation, coordinated linkage design, and integrated control electronics provides a mechanically efficient and responsive assistive platform distinct from conventional multi-actuator or pneumatic glove systems.

A significant portion of currently available or developmental robotic hand devices are designed primarily for clinic-based therapy and are not optimized for functional interaction with real-world objects during daily activities. Many such systems include dorsal and palmar structures that obstruct the palm, thereby limiting direct tactile engagement with objects. In addition, numerous devices require the user to remain seated with the arm positioned in a predetermined posture, restricting natural reach-and-grasp movements. As a result, the transfer of skills practiced in controlled clinical environments to real-life task performance may be limited.

Several commercially available motorized hand devices utilize pneumatic actuation to drive finger movement. These systems commonly perform preprogrammed cyclic passive flexion and extension movements or rely on external triggers, such as a switch operated by the contralateral hand, to initiate motion. Such devices typically lack integrated force sensing or intent-detection capability and therefore do not respond proportionally to residual voluntary effort. The absence of user-intent integration may reduce therapeutic engagement, limit adaptability across impairment levels, and diminish acceptance as a practical assistive device for daily use. Furthermore, certain pneumatic systems require tethering to external compressors or power units, increasing bulk and limiting portability. Their mechanical excursion ranges may also be constrained, restricting use to manipulation of very compliant objects and limiting their functional applicability across diverse object sizes and stiffnesses.

In contrast, the mHandSOME embodiment disclosed herein is configured to permit functional reach-and-grasp interaction with real objects in naturalistic environments. The device maintains a substantially unobstructed palmar surface and is designed for lightweight, untethered operation suitable for activities of daily living. Integrated force sensing and intent-detection algorithms enable voluntary, user-driven activation rather than purely passive cycling. The coordinated linkage and actuation architecture allows grasp and release of objects of varying size, shape, and stiffness, thereby expanding functional utility beyond preprogrammed motion patterns. By combining low-profile mechanical design, untethered power, and user-responsive control, the present invention addresses limitations of prior pneumatic and clinic-constrained systems while supporting both assistive use and therapeutic rehabilitation.

Other versions of disclosed embodiments for mHandSOME and published several papers on the device have been developed including: Sandison M, Casas R, Lum PS. HandMATE: wearable robotic hand exoskeleton and integrated android app for at-home strok rehabilitation. Proc Annu Int Conf IEEE Eng Med Biol Soc (EMBC). 202;2020:871-874; Casas R, Sandison M, Chen T, Lum PS. Clinical Test of a Wearable, High DOF, Spring Powered Hand Exoskeleton (HandSOME II). IEEE Trans Neural Syst Rehabil. 2021;29:1877-1885; Casas R, Sandison M, Nichols D, Martin K, Phan K, Chen T and Lum PS (2021) Home-Based Therapy After Stroke Using the Hand Spring Operated Movement Enhancer (HandSOME II). Front. Neurorobot. 15:773477. doi: 10.3389/fnbot.2021.773477; Chen J, Nichols D, Brokaw EB, Lum PS. Home-Based Therapy After Stroke Using the Hand Spring Operated Movement Enhancer (HandSOME). IEEE Trans Neural Syst Rehabil Eng. 2017 Dec;25(12):2305-2312; Brokaw EB, Black I, Holley RJ, Lum PS (2011) Hand Spring Operated Movement Enhancer (HandSOME): A Portable, Passive Hand Exoskeleton for Stroke Rehabilitation. IEEE Transactions on Neural Systems and Rehabilitation Engineering 19(4):391-9.

An early motorized embodiment, referred to as HandMATE, was developed to explore independently actuated digit control. In that configuration, five separate linear actuators were employed to drive individual finger movements, enabling discrete control of each digit. While this architecture provided a high degree of independent articulation, it introduced substantial mechanical and electronic complexity. The device required numerous discrete components, including a large number of individually fabricated structural elements, mechanical fasteners, pivot pins, and associated control hardware. Each actuator required dedicated sensing and amplification circuitry, resulting in multiple force sensors, multiple motor driver channels, and expanded processor input and output capacity to support pulse-width modulation control and sensor acquisition.

Testing of the HandMATE configuration revealed that although independent digit control was technically achievable, such granularity was not necessarily aligned with the primary functional needs of many users with stroke-related impairment. In practical use scenarios, consistent execution of a limited set of coordinated grasp patterns was found to be more valuable than fully independent finger articulation. Users emphasized the importance of performing bimanual functional tasks, such as stabilizing a jar with the impaired hand while opening a lid with the contralateral hand, holding a toothbrush while applying toothpaste, or supporting objects during daily activities. Precision tasks requiring isolated finger control, such as fine typing or pointing, were generally not identified as priority functional objectives by the tested user population.

These observations informed the evolution of subsequent embodiments toward mechanically coordinated multi-digit architectures capable of producing reliable, repeatable functional grasp patterns using simplified actuation schemes. By reducing the number of required actuators and consolidating motion through coordinated linkages, later embodiments achieved reduced mechanical complexity, lower part count, simplified electronics, improved reliability, and enhanced wearability while maintaining clinically relevant assistive functionality.

Compared to existing upper limb and hand assistive devices, the present disclosure integrates structural and functional features that address limitations observed in currently available systems. Many commercially available devices are designed primarily for supervised rehabilitation use and do not simultaneously provide practical assistive functionality for activities of daily living. In contrast, the mHandSOME embodiment is configured to deliver both immediate functional grasp assistance and structured rehabilitative support within a single platform. This hybrid assistive-rehabilitation capability enables users to perform daily tasks while also engaging in repetitive, goal-directed training that promotes long-term motor recovery. By supporting both functional independence and therapeutic progression, the device encourages sustained usage between formal therapy sessions.

In addition, many existing powered hand systems are relatively heavy, mechanically restrictive, or tethered to external compressors or control units, limiting portability and practical home use. The disclosed device is configured as a lightweight, low-profile, wearable system suitable for extended use in outpatient and home environments. Its untethered architecture and compact form factor permit natural arm positioning and real-world task performance rather than restricting the user to a fixed clinical posture.

Furthermore, certain robotic glove systems rely on fixed or preprogrammed motion patterns that do not adapt to user-generated input or object variability. The present invention provides coordinated, responsive multi-grip functionality that enables engagement of objects of varying size, shape, and stiffness. Through mechanical coupling and, in active embodiments, force-sensing and adaptive control, the device supports voluntary, user-driven grasp and release rather than purely passive cycling. This capability enhances applicability to essential daily tasks such as holding utensils, stabilizing containers, manipulating personal care items, and performing other bimanual activities.

From an implementation perspective, many advanced powered systems employ multiple independent actuators, complex electronics, or proprietary rental-based models, resulting in high acquisition or long-term usage costs. The disclosed architecture employs mechanically coordinated motion and, in certain embodiments, a reduced actuator count, thereby lowering system complexity and manufacturing burden while maintaining functional performance. The integration of real-time activity tracking and wireless communication further supports clinical documentation and monitoring, facilitating alignment with reimbursement pathways and structured rehabilitation programs.

Collectively, the combination of coordinated mechanical design, lightweight untethered operation, adaptive voluntary control, and integrated monitoring positions the disclosed system as a comprehensive platform for both home-based and outpatient rehabilitation while maintaining practical assistive functionality during daily activities.

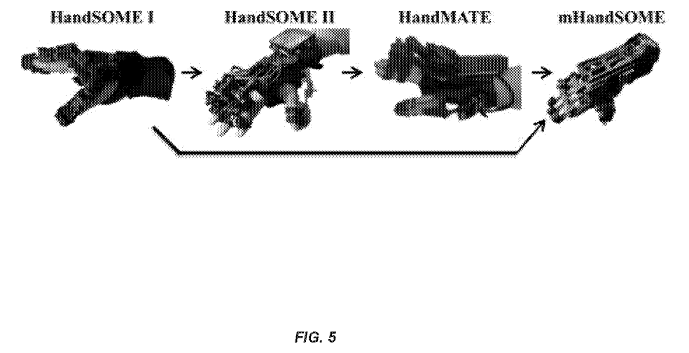

FIG. 5 illustrates the evolutionary progression of the disclosed hand exoskeleton systems from purely passive mechanical embodiments to actively powered configurations incorporating motorized actuation and electronic control. The figure depicts representative embodiments within the HandSOME family and the subsequent HandMATE system to demonstrate the structural and functional development of the technology.

In the illustrated progression, the earlier HandSOME embodiments are shown as passively powered wearable exoskeletons employing mechanically coupled linkages and resilient biasing members to coordinate movement of all fingers and the thumb into a single degree of freedom. These configurations rely on spring-based extension assistance and mechanical coupling to generate functional grasp patterns without active actuation.

The HandMATE embodiment is depicted as a motorized system incorporating multiple actuators and associated control electronics to provide independent digit actuation. While enabling powered assistance, this configuration introduces increased mechanical and electronic complexity.

The mHandSOME embodiment, as illustrated, integrates the simplified structural design principles of HandSOME I with powered actuation and control concepts derived from HandMATE. Specifically, mHandSOME retains the mechanically coupled architecture that coordinates movement of all fingers and the thumb into a single powered degree of freedom, while incorporating a linear actuator and integrated control electronics to provide active assistive torque. By combining a simplified mechanical coupling strategy with refined actuation and control methodology, mHandSOME achieves powered grasp assistance with reduced system complexity relative to multi-actuator configurations. The figure thus illustrates the technological evolution toward a coordinated, lightweight, and motorized hand exoskeleton architecture.

Thus, the mHandSOME embodiment represents an actively powered evolution of the updated HandSOME I platform, incorporating linear actuation and electronic control while retaining the coordinated mechanical architecture of the passive system. By building upon the mechanically coupled multi-digit design of HandSOME I, the mHandSOME achieves powered assistance without reverting to the high-complexity architecture of earlier multi-actuator systems.

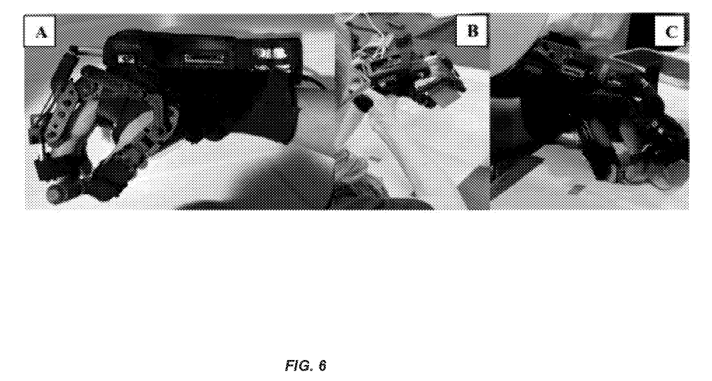

FIG. 6 illustrates representative views of the enhanced grasp configuration enabled by an actively powered hand exoskeleton.

FIG. 6A presents a side view of the device mounted on a user’s hand, showing the relative positioning of the finger linkages, thumb assembly, and associated passive articulation points. The side view highlights the additional proximal interphalangeal (PIP) joint degree of freedom in the fingers and the thumb carpometacarpal (CMC) flexion and extension degree of freedom, both of which contribute to increased curvature and improved conformity during grasp formation.

FIG. 6B provides an angled perspective view demonstrating the resulting C-grasp pattern achievable with the enhanced configuration. The fingers exhibit increased flexion curvature due to the added PIP articulation, while the thumb moves along a coordinated trajectory that supports stable engagement of round or cylindrical objects. The angled view illustrates the improved spatial relationship between the fingers and thumb during object enclosure.

FIG. 6C presents a front view of the thumb assembly in the current prototype configuration incorporating the new degree of freedom. The illustration demonstrates the modified thumb trajectory enabled by the added CMC flexion and extension articulation, which permits a more anatomically natural motion path. This enhanced thumb positioning improves comfort, alignment, and functional grasp capability compared to configurations lacking the additional degree of freedom. Together, the views of FIG. 6 depict the structural modifications and resulting grasp kinematics associated with the enhanced embodiment.

Relative to prior motorized configurations, including earlier designs employing multiple independent actuators, the updated mechanical architecture significantly simplifies the system. In certain embodiments, coordinated multi-digit motion is achieved using a reduced number of actuators, and in some implementations a single linear actuator drives synchronized finger and thumb movement through a shared transmission mechanism. This reduction in actuator count correspondingly reduces overall part count, mechanical interfaces, wiring complexity, control channel requirements, assembly time, system weight, and manufacturing cost. The simplified architecture enhances reliability and improves scalability for commercial production.

The mHandSOME embodiment further incorporates at least one force sensor configured to detect user-generated flexion effort. The force sensor provides input to the control system, enabling intent-responsive activation of the actuator for extension or flexion assistance. By allowing assistance to be triggered or modulated based on residual voluntary effort, the device supports more natural user interaction, improves comfort during wear, and enhances functional gripping capability relative to systems that rely solely on preprogrammed movement patterns.

A user-selectable control interface may also be provided, including a slider switch or equivalent control mechanism configured to command force-open and force-close modes. This feature allows users to manually initiate hand opening or closing assistance independent of force-sensor activation, thereby accommodating a range of impairment severities and task requirements. In certain configurations, the slider may be operable by the contralateral hand to enable independent control even in cases of limited residual motor function.

The mechanical and electronic integration further supports a compact, low-profile configuration that improves wearability and aesthetic acceptability during daily use. By minimizing dorsal protrusion and consolidating actuation components within the structural architecture, the device maintains a streamlined form factor suitable for extended wear.

In addition, the mHandSOME embodiment may include an integrated display or indicator module configured to present activity metrics, operational status, or therapy feedback. When combined with onboard sensing and wireless communication capabilities, the display functionality supports user engagement, performance tracking, and structured rehabilitation monitoring. Collectively, these enhancements provide a mechanically efficient, user-responsive, and commercially scalable powered exoskeleton system that addresses limitations of prior motorized designs while preserving coordinated functional grasp capability.

In an exemplary embodiment, the prototype employs a single linear actuator to drive coordinated motion of the finger metacarpophalangeal (MCP) joints and thumb carpometacarpal (CMC) adduction and abduction degrees of freedom. The actuator is mechanically coupled to the finger and thumb linkages through a shared transmission structure, thereby producing synchronized multi-digit movement while minimizing actuator count and system complexity. This architecture enables consistent formation of functional grasp patterns while reducing weight, part count, and control channel requirements relative to independently actuated designs.

Additional articulation is provided through passive degrees of freedom at the finger proximal interphalangeal (PIP) joints and at the thumb CMC flexion and extension axis. Incorporation of these additional passive joints permits increased finger curvature and more natural thumb positioning during grasp formation, thereby enabling more flexible grasp patterns and expanding the range of objects that may be engaged, including round, cylindrical, and spherical objects. Extension assistance at these additional joints is achieved using spring-powered biasing elements configured to provide restorative torque while preserving voluntary flexion capability.

To accommodate anatomical variability, the finger and thumb attachment points are configured to be longitudinally extendable to correspond with individual finger lengths. The thumb attachment component includes rotational adjustment features to align with the user’s native thumb orientation and CMC joint positioning. Each finger assembly incorporates an adjustable distal ring formed from a compliant material, such as elastic nylon, secured using hook-and-loop fasteners or equivalent fastening mechanisms. This arrangement facilitates simplified donning and secure attachment. Straps may be selectively positioned distally along the middle phalanx or aligned near the PIP joint to prevent undesired finger curling while maintaining appropriate joint alignment. The thumb strap, similarly formed from compliant material, may be adjusted to restrict excessive curling or permit controlled flexion depending on user needs and is typically positioned near the thumb interphalangeal (IP) joint to optimize alignment and stability.

The control electronics are configured for fully tetherless, battery-powered operation. A dedicated printed circuit board integrates a processor, motor driver circuitry, power management components, and communication interfaces. A rechargeable battery is incorporated to permit untethered use during daily activities and home-based therapy. The actuator and control system integration builds upon prior development experience while being optimized for the simplified single-actuator architecture of the present embodiment.

In addition to force sensor-based intent detection, the device includes an alternative manual control interface comprising a slider potentiometer operatively coupled to the processor. The slider control permits users with minimal residual hand function to initiate or modulate actuator movement using the contralateral hand. This dual-control strategy enhances accessibility across a range of impairment severities and allows customization of control modality based on user preference and functional capacity. Together, the coordinated mechanical architecture, passive supplemental articulation, adjustable ergonomic features, and integrated untethered control electronics represent a preferred embodiment for practicing the invention.

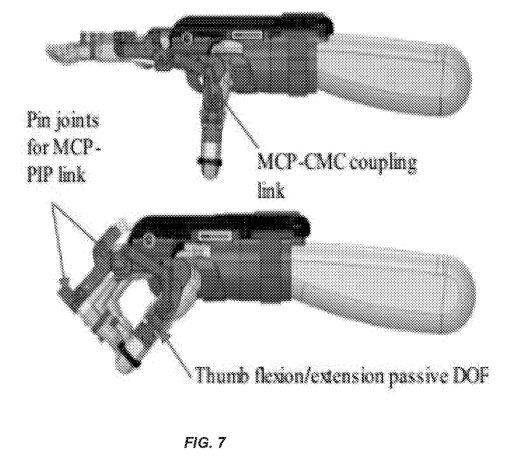

FIG. 7 illustrates a computer-aided design (CAD) representation of an enhanced low-profile embodiment of the hand exoskeleton device. The illustrated configuration demonstrates structural refinements directed toward reducing overall device height and dorsal protrusion, thereby improving comfort, wearability, and aesthetic integration during extended daily use. The compact arrangement of the linkage assemblies, actuator housing, and control electronics is configured to minimize bulk while maintaining mechanical alignment with the underlying anatomical joints.

The CAD depiction further illustrates adjustable length features incorporated into the finger and thumb attachment structures. These user-friendly length adjustment mechanisms permit rapid customization to accommodate different hand sizes and phalangeal lengths without requiring disassembly or specialized tools. The adjustable architecture facilitates individualized fitting and supports repeatable anatomical alignment.

The design also emphasizes self-donning capability. Structural interfaces, including accessible straps, adjustable distal rings, and ergonomically positioned attachment points, are arranged to enable users to independently secure and remove the device, including individuals with limited dexterity in the impaired hand.

The illustrated embodiment incorporates an upgraded actuator system configured to provide faster and more responsive motor performance. The motor assembly is integrated within the low-profile housing while maintaining sufficient torque output for functional grasp assistance. A wireless activation mechanism is also incorporated, permitting cable-free operation and eliminating tethering constraints that could restrict movement during activities of daily living.

Additionally, the embodiment shown in FIG. 7 includes an integrated touchscreen display positioned on the dorsal housing. The touchscreen provides direct user control of operating modes, assistance levels, and therapy parameters, and may display activity metrics, performance feedback, and device status information. The control electronics are configured to enable seamless communication with a companion software application, ensuring real-time data tracking, performance monitoring, and interactive engagement. Through wireless connectivity, session data may be transmitted to external devices to support therapy personalization and longitudinal monitoring. Together, the features illustrated in FIG. 6A demonstrate a refined, compact, and electronically integrated embodiment of the disclosed hand exoskeleton system.

In the embodiment illustrated in FIG. 7, the coordinated motion between joint segments is facilitated by a series of pin joints strategically positioned to define rotational axes corresponding to anatomical joint locations. These pin joints serve as low-profile pivot interfaces that permit controlled relative rotation between adjacent linkage members while maintaining structural alignment and minimizing friction.

With respect to the MCP–PIP linkage, a pin joint is disposed at or near the mechanical axis corresponding to the metacarpophalangeal (MCP) joint, allowing the primary finger linkage to rotate relative to the dorsal support structure. A secondary pin joint is positioned at or near the proximal interphalangeal (PIP) joint axis, enabling articulation between proximal and intermediate linkage segments. The MCP–PIP link is configured such that rotation at the MCP joint produces coordinated motion at the PIP joint through a mechanical coupling element, while still permitting passive compliance at the PIP joint in embodiments incorporating a passive degree of freedom. The pin joints may comprise cylindrical pivot pins, shoulder screws, dowel pins, or equivalent rotational fasteners secured within aligned apertures of adjoining linkage members. Bushings, low-friction liners, or bearing inserts may be incorporated to reduce wear and ensure smooth articulation.

The MCP–CMC coupling link is similarly implemented using pin joints that define rotational axes corresponding to the MCP joints of the fingers and the carpometacarpal (CMC) joint of the thumb. A pin joint at the MCP axis permits rotation of the finger linkage relative to the dorsal frame, while a corresponding pin joint at the thumb CMC interface allows rotation of the thumb linkage about the abduction/adduction axis. The coupling link mechanically interconnects these pivot points such that rotation at one joint produces synchronized motion at the other, thereby achieving coordinated grasp kinematics. The use of pin joints in this coupling arrangement maintains a compact form factor and enables efficient transmission of force while preserving anatomical alignment.

All documents, patents, journal articles and other materials cited in the present application are incorporated herein by reference.

While the present disclosure has been disclosed with references to certain embodiments, numerous modification, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims, and equivalents thereof.

What is claimed is:

1. A wearable hand exoskeleton device comprising:
a dorsal support structure configured to be positioned along a back of a user’s hand;
a plurality of finger assemblies coupled to the dorsal support structure, each finger assembly configured to attach to a respective finger of the user;
a thumb assembly coupled to the dorsal support structure and configured to attach to a thumb of the user;
a linkage mechanism coupling motion of metacarpophalangeal (MCP) joints of the fingers with motion of a carpometacarpal (CMC) joint of the thumb; and
at least one resilient biasing member configured to provide extension assistance to the MCP joints and the CMC joint,
wherein the linkage mechanism coordinates movement of the fingers and thumb to generate a functional grasp pattern.

2. The device of claim 1, wherein the resilient biasing member is routed through the linkage mechanism such that extension torque decreases as the fingers flex.

3. The device of claim 1, further comprising a passive degree of freedom at a proximal interphalangeal (PIP) joint of at least one finger.

4. The device of claim 3, further comprising a second resilient biasing member configured to provide extension assistance at the PIP joint.

5. The device of claim 1, further comprising a passive thumb flexion/extension degree of freedom at the CMC joint.

6. The device of claim 1, wherein the plurality of finger assemblies include adjustable distal rings configured to accommodate varying finger lengths.

7. The device of claim 1, wherein the linkage mechanism comprises a four-bar linkage.

8. The device of claim 1, wherein the resilient biasing member comprises a coil spring.

9. The device of claim 1, wherein the resilient biasing member comprises an elastic band.

10. The device of claim 1, wherein tension provided by the resilient biasing member is adjustable via a tension adjustment mechanism.

11. A wearable hand exoskeleton device comprising:
a dorsal frame configured to be worn on a back of a user’s hand;
a plurality of finger linkages operatively coupled to respective fingers;
a thumb linkage operatively coupled to a thumb;
a coupling mechanism configured to coordinate movement of the finger linkages and the thumb linkage;
a linear actuator mechanically coupled to the coupling mechanism; and
a control system configured to actuate the linear actuator to assist extension and flexion of the fingers and thumb.

12. The device of claim 11, further comprising a force sensor configured to detect user-generated flexion force.

13. The device of claim 12, wherein the control system activates the linear actuator in response to the detected flexion force.

14. The device of claim 11, wherein the linear actuator is a single actuator configured to drive coordinated movement of multiple fingers.

15. The device of claim 11, further comprising a battery configured for untethered operation.

16. The device of claim 11, further comprising a user-operated switch configured to selectively force open or force close the hand.

17. The device of claim 11, further comprising a slider potentiometer configured to enable activation using a contralateral hand.

18. The device of claim 11, wherein the control system includes a printed circuit board (PCB) and motor driver circuitry.

19. The device of claim 11, further comprising at least one passive spring configured to assist motion at a PIP joint.

20. The device of claim 11, wherein the device weighs between approximately .316 and .451 kilograms.

21. A hand rehabilitation system comprising:
a wearable hand exoskeleton device including
a dorsal frame,
a plurality of finger assemblies,
a thumb assembly, and
at least one actuation element configured to assist grasp and extension;
a position sensor configured to detect angular displacement of at least one joint;
a control unit configured to record movement data; and
a wireless communication module configured to transmit the movement data to an external computing device.

22. The system of claim 21, wherein the external computing device comprises a mobile application configured to display activity metrics.

23. The system of claim 21, wherein the control unit records position data at a sampling frequency of at least 20 Hz.

24. The system of claim 21, wherein the mobile application includes a gamified therapy interface.

25. The system of claim 21, wherein the system is configured to track total repetitions of grasp and release cycles.

26. The system of claim 21, wherein the actuation element comprises a linear actuator.

27. The system of claim 21, wherein the actuation element comprises a passive spring assembly.

28. The system of claim 21, wherein the control unit adjusts torque assistance based on recorded movement data.

29. The system of claim 21, further comprising a touchscreen display disposed on the dorsal frame.

30. The system of claim 21, configured for use in home-based rehabilitation.

31. A method of assisting and rehabilitating hand function of a user, comprising:
positioning a wearable hand exoskeleton on a dorsal side of the user’s hand, the exoskeleton including a plurality of finger linkages, a thumb linkage, and at least one assistance element configured to provide extension torque;
coupling motion of metacarpophalangeal (MCP) joints of the fingers with motion of a carpometacarpal (CMC) joint of the thumb using a linkage mechanism;
providing extension assistance to the fingers and thumb through at least one resilient biasing member or actuator;
allowing the user to voluntarily flex the fingers against the extension assistance to grasp an object; and
assisting reopening of the hand to release the object.

32. The method of claim 31, wherein the extension assistance decreases as the fingers flex.

33. The method of claim 31, further comprising providing passive extension assistance at a proximal interphalangeal (PIP) joint.

34. The method of claim 31, wherein the assistance element comprises a linear actuator.

35. The method of claim 34, further comprising:
detecting user-generated flexion force using a force sensor; and
activating the linear actuator in response to the detected flexion force.

36. The method of claim 31, further comprising enabling the user to select a force-open mode or a force-close mode via a user interface.

37. The method of claim 31, further comprising:
recording joint position data during grasp and release cycles; and
storing the data for therapy monitoring.

38. The method of claim 37, further comprising transmitting the data wirelessly to an external computing device.

39. The method of claim 31, wherein the method is performed during execution of activities of daily living (ADLs).

40. The method of claim 31, further comprising adjusting extension torque to match a tone profile of the user.

41. A non-transitory computer-readable medium storing instructions that, when executed by a processor of a wearable hand exoskeleton device, cause the device to:
receive input from at least one sensor associated with a finger or thumb linkage;
determine a user intent to flex or extend the hand based on the sensor input;
control an actuation element to provide assistive torque to the fingers and thumb; and
record movement data associated with grasp and release cycles.

42. The non-transitory computer-readable medium of claim 41, wherein the at least one sensor comprises a force sensor configured to detect user-generated flexion force.

43. The non-transitory computer-readable medium of claim 41, wherein determining user intent includes comparing sensed force to a threshold value.

44. The non-transitory computer-readable medium of claim 41, wherein the actuation element comprises a linear actuator.

45. The non-transitory computer-readable medium of claim 41, wherein controlling the actuation element includes coordinating motion of multiple fingers using a single actuator.

46. The non-transitory computer-readable medium of claim 41, further causing the device to adjust an assistance torque profile based on recorded movement data.

47. The non-transitory computer-readable medium of claim 41, further causing the device to transmit movement data to a remote computing device via a wireless communication module.

48. The non-transitory computer-readable medium of claim 47, wherein the remote computing device executes a mobile application configured to display therapy metrics.

49. The non-transitory computer-readable medium of claim 41, further causing the device to operate in a force-open mode or a force-close mode in response to user input.

50. The non-transitory computer-readable medium of claim 41, wherein the recorded movement data includes at least one of: joint angle, repetition count, session duration, grip amplitude, or range of motion.
